(19) United States
(12) Patent Application Publication
(10) Pub. No.: US 2026/0052456 A1
(43) Pub. Date: Feb. 19, 2026

(54) CELL SEARCH PROCEDURES FOR LICENSED OR SHARED RADIO FREQUENCY SPECTRUM BANDS

(71) Applicant: QUALCOMM INCORPORATED, San Diego, CA (US)

(72) Inventors: Chao Wei, Beijing (CN); Hao Xu, Beijing (CN); Jing Jiang, San Diego, CA (US); Kangqi Liu, San Diego, CA (US)

(21) Appl. No.: 19/102,360

(22) PCT Filed: Sep. 16, 2022
(86) PCT No.: PCT/CN2022/119184

§ 371 Date: Feb. 7, 2025

(51) Int. Cl. H04W 48/16; H04W 16/14; H04W 76/10

(52) U.S. Cl. CPC H04W 48/16; H04W 16/14; H04W 76/10

(57) ABSTRACT

Methods, systems, and devices for wireless communication are described. A user equipment (UE) may perform a cell search procedure to attach to a cell of a network entity. In some examples, if the UE is unable to determine an operating mode of the cell, the UE may receive one or more system information messages via the cell using a first operating mode associated with a shared radio frequency (RF) spectrum band. The one or more system information messages may indicate that the operating mode of the cell is either the first operating mode associated with the shared RF spectrum band or a second operating mode associated with a licensed RF spectrum band. Accordingly, the UE may establish a connection with the network entity via the cell using the operating mode indicated by the one or more system information messages.

### CROSS REFERENCE

This application is a 371 National Stage of PCT Application No. PCT/CN2022/119184, filed on Sep. 16, 2022, entitled “CELL SEARCH PROCEDURES FOR LICENSED OR SHARED RADIO FREQUENCY SPECTRUM BANDS,” and assigned to the assignee hereof. The disclosure of the prior Application is considered part of and is incorporated by reference into this patent application.

### FIELD OF TECHNOLOGY

The following relates to wireless communication, including cell search procedures for licensed or shared radio frequency (RF) spectrum bands.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a device may use a first set of parameters for initial access in a first radio frequency (RF) spectrum band and a second (different) set of parameters for initial access in a second RF spectrum band. In some cases, however, the device may be unable to determine whether a carrier frequency is associated with the first RF spectrum band or the second RF spectrum band, which may adversely impact cell search processes at the device.

### SUMMARY

The described techniques relate to improved methods, systems, devices, and apparatuses that support cell search procedures for licensed or shared radio frequency (RF) spectrum bands. For example, the described techniques may improve the efficiency of cell search procedures at a user equipment (UE). In accordance with aspects of the present disclosure, a UE may perform a cell search procedure to attach to a cell of a network entity. In some examples, if the UE is unable to pre-determine an operating mode of the cell, the UE may receive one or more system information messages via the cell using a first operating mode associated with a shared RF spectrum band. The one or more system information messages may indicate that the operating mode of the cell is either the first operating mode associated with the shared RF spectrum band or a second operating mode associated with a licensed RF spectrum band. Accordingly, the UE may establish a connection with the network entity via the cell using the operating mode indicated by the one or more system information messages.

A method for wireless communication at a UE is described. The method may include performing a cell search procedure to attach to a cell of a network entity, where an operating mode of the cell is unknown to the UE. The method may further include receiving one or more system information messages via the cell using a first operating mode associated with a shared RF spectrum band based on the operating mode of the cell being unknown to the UE, the one or more system information messages indicating that the operating mode of the cell is either the first operating mode associated with the shared RF spectrum band or a second operating mode associated with a licensed RF spectrum band. The method may further include establishing a connection with the network entity via the cell using the operating mode indicated by the one or more system information messages.

An apparatus for wireless communication at a UE is described. The apparatus may include a processor, memory coupled with the processor, and instructions stored in the memory. The instructions may be executable by the processor to cause the apparatus to perform a cell search procedure to attach to a cell of a network entity, where an operating mode of the cell is unknown to the UE. The instructions may be further executable by the processor to cause the apparatus to receive one or more system information messages via the cell using a first operating mode associated with a shared RF spectrum band based on the operating mode of the cell being unknown to the UE, the one or more system information messages indicating that the operating mode of the cell is either the first operating mode associated with the shared RF spectrum band or a second operating mode associated with a licensed RF spectrum band. The instructions may be further executable by the processor to cause the apparatus to establish a connection with the network entity via the cell using the operating mode indicated by the one or more system information messages.

Another apparatus for wireless communication at a UE is described. The apparatus may include means for performing a cell search procedure to attach to a cell of a network entity, where an operating mode of the cell is unknown to the UE. The apparatus may further include means for receiving one or more system information messages via the cell using a first operating mode associated with a shared RF spectrum band based on the operating mode of the cell being unknown to the UE, the one or more system information messages indicating that the operating mode of the cell is either the first operating mode associated with the shared RF spectrum band or a second operating mode associated with a licensed RF spectrum band. The apparatus may further include means for establishing a connection with the network entity via the cell using the operating mode indicated by the one or more system information messages.

A non-transitory computer-readable medium storing code for wireless communication at a UE is described. The code may include instructions executable by a processor to perform a cell search procedure to attach to a cell of a network entity, where an operating mode of the cell is unknown to the UE. The instructions may be further executable by the processor to receive one or more system information messages via the cell using a first operating mode associated with a shared RF spectrum band based on the operating mode of the cell being unknown to the UE, the one or more system information messages indicating that the operating mode of the cell is either the first operating mode associated with the shared RF spectrum band or a second operating mode associated with a licensed RF spectrum band. The instructions may be further executable by the processor to establish a connection with the network entity via the cell using the operating mode indicated by the one or more system information messages.

In some examples of the methods, apparatuses, and non-transitory computer-readable media described herein, receiving the one or more system information messages may include operations, features, means, or instructions for receiving, via the cell and in accordance with the cell search procedure, a master information block (MIB) including one or more bits that indicate an operating mode to use for reception of one or more system information blocks (SIB) and synchronization signal blocks (SSB), the operating mode including either the first operating mode or the second operating mode.

Some examples of the methods, apparatuses, and non-transitory computer-readable media described herein may further include operations, features, means, or instructions for determining one or more of a subcarrier spacing (SCS), a bandwidth, a maximum quantity of candidate resources available for transmission of SSBs, a frequency offset, or a time duration to use for reception of the one or more SIBs and SSBs based on the operating mode of the cell.

In some examples of the methods, apparatuses, and non-transitory computer-readable media described herein, the MIB that indicates one or more of a system frame number (SFN), a common SCS, an SSB subcarrier offset, a demodulation reference signal (DMRS) position field, a downlink control channel resource configuration, a control resource set (CORESET) configuration, a cell barring parameter, or an intra-frequency reselection parameter for the cell search procedure.

In some examples of the methods, apparatuses, and non-transitory computer-readable media described herein, one or both of a spare bit or a future extension bit in the MIB indicate the operating mode of the cell.

In some examples of the methods, apparatuses, and non-transitory computer-readable media described herein, receiving the one or more system information messages may include operations, features, means, or instructions for monitoring a set of SSB resources and a CORESET in accordance with the first operating mode associated with the shared RF spectrum band.

In some examples of the methods, apparatuses, and non-transitory computer-readable media described herein, receiving the one or more system information messages may include operations, features, means, or instructions for receiving one or more SSBs via the set of SSB resources.

In some examples of the methods, apparatuses, and non-transitory computer-readable media described herein, receiving the one or more system information messages may include operations, features, means, or instructions for receiving, via the CORESET, a first SIB indicating that the cell is operating in either the licensed RF spectrum band or the shared RF spectrum band.

In some examples of the methods, apparatuses, and non-transitory computer-readable media described herein, receiving the first SIB may include operations, features, means, or instructions for monitoring the CORESET using one or more of a SCS, a bandwidth, a resource block (RB) offset, or a time duration associated with the first operating mode.

In some examples of the methods, apparatuses, and non-transitory computer-readable media described herein, receiving the one or more system information messages may include operations, features, means, or instructions for receiving, via the cell and in accordance with the cell search procedure, a SIB including an information element (IE) that indicates a first set of SSB indices corresponding to a first set of resources of multiple candidate resources used for transmission of SSBs.

In some examples of the methods, apparatuses, and non-transitory computer-readable media described herein, a first system information message of the one or more system information messages indicates that the cell is using the second operating mode associated with the licensed RF spectrum band and a second system information message of the one or more system information messages indicates a first set of resources of multiple candidate resources used for transmission of SSBs.

Some examples of the methods, apparatuses, and non-transitory computer-readable media described herein may further include operations, features, means, or instructions for determining whether a second set of resources of the multiple candidate resources is available for downlink shared channel resource mapping based on the second operating mode of the cell and a quasi-co-location (QCL) relationship between the first set of resources and the second set of resources.

Some examples of the methods, apparatuses, and non-transitory computer-readable media described herein may further include operations, features, means, or instructions for monitoring for a downlink message in accordance with the downlink shared channel resource mapping.

Some examples of the methods, apparatuses, and non-transitory computer-readable media described herein may further include operations, features, means, or instructions for identifying a QCL relationship between the first set of resources and a second set of resources of the multiple candidate resources based on a set of SSB indices associated with the first set of resources and a QCL parameter indicated by a MIB or a dedicated radio resource control (RRC) message.

Some examples of the methods, apparatuses, and non-transitory computer-readable media described herein may further include operations, features, means, or instructions for receiving an indication of a first set of resources of multiple candidate resources used for transmission of SSBs.

Some examples of the methods, apparatuses, and non-transitory computer-readable media described herein may further include operations, features, means, or instructions for determining that all of the multiple candidate resources except the first set of resources are available for downlink shared channel resource mapping based on the one or more system information messages indicating that the cell is operating in the licensed RF spectrum band.

Some examples of the methods, apparatuses, and non-transitory computer-readable media described herein may further include operations, features, means, or instructions for monitoring for a downlink message in accordance with the downlink shared channel resource mapping.

In some examples of the methods, apparatuses, and non-transitory computer-readable media described herein, receiving the one or more system information messages may include operations, features, means, or instructions for receiving, via the cell and in accordance with the cell search procedure, a first system information message indicating a first set of resources of multiple candidate resources used for transmission of SSBs.

Some examples of the methods, apparatuses, and non-transitory computer-readable media described herein may further include operations, features, means, or instructions for receiving a downlink message via a second set of resources of the multiple candidate resources based on the first system information message, where the second set of resources is determined according to the operating mode of the cell.

A method for wireless communication at a network entity is described. The method may include performing a cell search procedure in accordance with an operating mode of a cell of the network entity, where the operating mode of the cell is unknown to a UE. The method may further include outputting, via the cell and in accordance with the cell search procedure, one or more system information messages indicating that the operating mode of the cell is either a first operating mode associated with a shared RF spectrum band or a second operating mode associated with a licensed RF spectrum band. The method may further include establishing a connection with the UE via the cell using the operating mode indicated by the one or more system information messages.

An apparatus for wireless communication at a network entity is described. The apparatus may include a processor, memory coupled with the processor, and instructions stored in the memory. The instructions may be executable by the processor to cause the apparatus to perform a cell search procedure in accordance with an operating mode of a cell of the network entity, where the operating mode of the cell is unknown to a UE. The instructions may be further executable by the processor to cause the apparatus to output, via the cell and in accordance with the cell search procedure, one or more system information messages indicating that the operating mode of the cell is either a first operating mode associated with a shared RF spectrum band or a second operating mode associated with a licensed RF spectrum band. The instructions may be further executable by the processor to cause the apparatus to establish a connection with the UE via the cell using the operating mode indicated by the one or more system information messages.

Another apparatus for wireless communication at a network entity is described. The apparatus may include means for performing a cell search procedure in accordance with an operating mode of a cell of the network entity, where the operating mode of the cell is unknown to a UE. The apparatus may further include means for outputting, via the cell and in accordance with the cell search procedure, one or more system information messages indicating that the operating mode of the cell is either a first operating mode associated with a shared RF spectrum band or a second operating mode associated with a licensed RF spectrum band. The apparatus may further include means for establishing a connection with the UE via the cell using the operating mode indicated by the one or more system information messages.

A non-transitory computer-readable medium storing code for wireless communication at a network entity is described. The code may include instructions executable by a processor to perform a cell search procedure in accordance with an operating mode of a cell of the network entity, where the operating mode of the cell is unknown to a UE. The instructions may be further executable by the processor to output, via the cell and in accordance with the cell search procedure, one or more system information messages indicating that the operating mode of the cell is either a first operating mode associated with a shared RF spectrum band or a second operating mode associated with a licensed RF spectrum band. The instructions may be further executable by the processor to establish a connection with the UE via the cell using the operating mode indicated by the one or more system information messages.

In some examples of the methods, apparatuses, and non-transitory computer-readable media described herein, outputting the one or more system information messages may include operations, features, means, or instructions for outputting, via the cell and in accordance with the cell search procedure, a MIB including one or more bits that indicate an operating mode to use for reception of one or more SIBs and SSBs, the operating mode including either the first operating mode or the second operating mode.

Some examples of the methods, apparatuses, and non-transitory computer-readable media described herein may further include operations, features, means, or instructions for determining one or more of a SCS, a bandwidth, a maximum quantity of candidate resources available for transmission of SSBs, a frequency offset, or a time duration to use for transmission of the one or more SIBs and SSBs based on the operating mode of the cell.

In some examples of the methods, apparatuses, and non-transitory computer-readable media described herein, the MIB that indicates one or more of an SFN, a common SCS, an SSB subcarrier offset, a DMRS position field, a downlink control channel resource configuration, a CORESET configuration, a cell barring parameter, or an intra-frequency reselection parameter for the cell search procedure.

In some examples of the methods, apparatuses, and non-transitory computer-readable media described herein, one or both of a spare bit or a future extension bit in the MIB indicate the operating mode of the cell.

In some examples of the methods, apparatuses, and non-transitory computer-readable media described herein, outputting the one or more system information messages may include operations, features, means, or instructions for outputting one or more SSBs via a set of SSB resources in accordance with the first operating mode associated with the shared RF spectrum band.

In some examples of the methods, apparatuses, and non-transitory computer-readable media described herein, outputting the one or more system information messages may include operations, features, means, or instructions for outputting, via a CORESET, a first SIB indicating that the cell is operating in either the licensed RF spectrum band or the shared RF spectrum band.

In some examples of the methods, apparatuses, and non-transitory computer-readable media described herein, outputting the first SIB may include operations, features, means, or instructions for outputting the first SIB via the CORESET using one or more of a SCS, a bandwidth, an RB offset, or a time duration associated with the first operating mode.

In some examples of the methods, apparatuses, and non-transitory computer-readable media described herein, outputting the one or more system information messages may include operations, features, means, or instructions for outputting, via the cell and in accordance with the cell search procedure, a SIB including an IE that indicates a first set of SSB indices corresponding to a first set of resources of multiple candidate resources used for transmission of SSBs.

In some examples of the methods, apparatuses, and non-transitory computer-readable media described herein, a first system information message of the one or more system information messages indicates that the cell is using the second operating mode associated with the licensed RF spectrum band and a second system information message of the one or more system information messages indicates a first set of resources of multiple candidate resources used for transmission of SSBs.

Some examples of the methods, apparatuses, and non-transitory computer-readable media described herein may further include operations, features, means, or instructions for determining whether a second set of resources of the multiple candidate resources is available for downlink shared channel resource mapping based on the second operating mode of the cell and a QCL relationship between the first set of resources and the second set of resources and outputting a downlink message in accordance with the downlink shared channel resource mapping.

Some examples of the methods, apparatuses, and non-transitory computer-readable media described herein may further include operations, features, means, or instructions for identifying a QCL relationship between the first set of resources and a second set of resources of the multiple candidate resources based on a set of SSB indices associated with the first set of resources and a QCL parameter indicated by a MIB or a dedicated RRC message.

Some examples of the methods, apparatuses, and non-transitory computer-readable media described herein may further include operations, features, means, or instructions for outputting an indication of a first set of resources of multiple candidate resources used for transmission of SSBs.

Some examples of the methods, apparatuses, and non-transitory computer-readable media described herein may further include operations, features, means, or instructions for determining that all of the multiple candidate resources except the first set of resources are available for downlink shared channel resource mapping in accordance with the second operating mode associated with the licensed RF spectrum band.

Some examples of the methods, apparatuses, and non-transitory computer-readable media described herein may further include operations, features, means, or instructions for outputting a downlink message in accordance with the downlink shared channel resource mapping.

In some examples of the methods, apparatuses, and non-transitory computer-readable media described herein, outputting the one or more system information messages may include operations, features, means, or instructions for outputting, via the cell and in accordance with the cell search procedure, a first SIB indicating a first set of resources of multiple candidate resources used for transmission of SSBs.

Some examples of the methods, apparatuses, and non-transitory computer-readable media described herein may further include operations, features, means, or instructions for performing a listen-before-talk (LBT) procedure in accordance with the first operating mode of the cell and outputting one or more downlink messages or SSBs based on a result of the LBT procedure.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail or purchasing devices, medical devices, artificial intelligence (AI)-enabled devices). While some examples may or may not be specifically directed to use cases or applications, a wide assortment of applicability of described innovations may occur.

Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF chains, power amplifiers, modulators, buffer, processor(s), interleaver(s), adders, summers). It is intended that innovations described herein may be practiced in a wide variety of devices, chip-level components, systems, distributed arrangements, or end-user devices of varying sizes, shapes, and constitutions.

### BRIEF DESCRIPTION OF THE DRAWINGS

FIG. 1 illustrates an example of a wireless communications system that supports cell search procedures for licensed or shared radio frequency (RF) spectrum bands in accordance with one or more aspects of the present disclosure.

FIG. 2 illustrates an example of a network architecture that supports cell search procedures for licensed or shared RF spectrum bands in accordance with one or more aspects of the present disclosure.

FIG. 3 illustrates an example of a wireless communications system that supports cell search procedures for licensed or shared RF spectrum bands in accordance with one or more aspects of the present disclosure.

FIGS. 4A and 4B illustrate examples of resource diagrams that support cell search procedures for licensed or shared RF spectrum bands in accordance with one or more aspects of the present disclosure.

FIG. 5 illustrates an example of a resource diagram that supports cell search procedures for licensed or shared RF spectrum bands in accordance with one or more aspects of the present disclosure.

FIGS. 6A and 6B illustrate examples of resource diagrams that support cell search procedures for licensed or shared RF spectrum bands in accordance with one or more aspects of the present disclosure.

FIG. 7 illustrates an example of a process flow that supports cell search procedures for licensed or shared RF spectrum bands in accordance with one or more aspects of the present disclosure.

FIGS. 8 and 9 show block diagrams of devices that support cell search procedures for licensed or shared RF spectrum bands in accordance with one or more aspects of the present disclosure.

FIG. 10 shows a block diagram of a communications manager that supports cell search procedures for licensed or shared RF spectrum bands in accordance with one or more aspects of the present disclosure.

FIG. 11 shows a diagram of a system including a device that supports cell search procedures for licensed or shared RF spectrum bands in accordance with one or more aspects of the present disclosure.

FIGS. 12 and 13 show block diagrams of devices that support cell search procedures for licensed or shared RF spectrum bands in accordance with one or more aspects of the present disclosure.

FIG. 14 shows a block diagram of a communications manager that supports cell search procedures for licensed or shared RF spectrum bands in accordance with one or more aspects of the present disclosure.

FIG. 15 shows a diagram of a system including a device that supports cell search procedures for licensed or shared RF spectrum bands in accordance with one or more aspects of the present disclosure.

FIGS. 16 through 19 show flowcharts illustrating methods that support cell search procedures for licensed or shared RF spectrum bands in accordance with one or more aspects of the present disclosure.

### DETAILED DESCRIPTION

In some wireless communications systems, a user equipment (UE) may perform a cell search procedure to establish a connection with a network entity. The UE may perform the cell search procedure by tuning to a specific carrier frequency (equivalently referred to herein as a component carrier (CC) or a cell), detecting one or more synchronization signal blocks (SSB), receiving a broadcast message via a physical broadcast channel (PBCH), and acquiring system information for a cell of the network entity. The broadcast message may include a master information block (MIB) that indicates the location of an initial control resource set (CORESET). The UE may monitor this CORESET (referred to herein as CORESET #0) for one or more system information blocks (SIB), which may provide the UE with information that can be used to establish a connection with the network entity.

Cell search procedures in shared (e.g., unlicensed, or shared licensed) radio frequency (RF) spectrum bands may be different from cell search procedures in licensed RF spectrum bands. For example, a network entity may be required to perform a successful listen-before-talk (LBT) procedure before transmitting one or more SSBs in a shared RF spectrum band. Additionally, some CORESET configuration parameters (e.g., bandwidth, subcarrier spacing (SCS), physical resource block (PRB) offsets) may vary for shared and licensed RF spectrum bands. In some cases, however, a UE may be unable to determine whether a carrier is associated with a shared RF spectrum band or a licensed RF spectrum band.

For example, some portions of frequency range 1 (FR1), such as the 6 gigahertz (GHz) RF spectrum band, may be designated for shared (e.g., unlicensed, or shared licensed) operations in some geographic regions and licensed operations in other geographic regions. As used herein, a geographic region may refer to an International Telecommunication Union (ITU) region, continent, country, country region, prefecture, province, county, district, city, time zone, or other defined geographic area. Additionally, or alternatively, in some systems, portions of the 6 GHZ RF spectrum band may be unlicensed for indoor deployments and licensed for outdoor deployments.

Aspects of the present disclosure support techniques for improving cell search procedures in the 6 GHZ RF spectrum band. In accordance with the described techniques, a UE operating in the 6 GHz RF spectrum band may initially access the 6 GHz RF spectrum band under the assumption that the 6 GHz RF spectrum band is designated for shared operations. For example, the UE may monitor for SSBs and SIBs using parameters that are specific to an unlicensed operating mode. The UE may determine whether a cell (carrier) in the 6 GHZ RF spectrum band is operating in a licensed mode or an unlicensed (or other shared) mode based on a field in MIB or SIB1. If the UE determines that the cell is operating in a licensed spectrum, the UE may switch to using parameters that are specific to a licensed operating mode. Otherwise, the UE may continue using the unlicensed operating mode for the cell search procedure.

The UE may receive one or more SSBs or downlink messages from the network entity according to the operating mode of the cell. In some examples, a field in SIB1 (e.g., ssb-PositionInBurst) may indicate a first set of resources used for transmission of one or more SSBs. These resources may be unavailable for physical downlink shared channel (PDSCH) resource mapping at the UE. The first set of resources may have a quasi-co-location (QCL) relationship with a second set of resources. The UE may identify this QCL relationship based on a QCL factor signaled via system information or dedicated radio resource control (RRC) signaling. If the cell is operating in a shared RF spectrum band, the second set of resources may also be unavailable for PDSCH resource mapping at the UE. As such, the UE may perform PDSCH resource mapping and rate matching according to the determined spectrum type (shared or licensed) of the cell.

Aspects of the present disclosure may be implemented to realize one or more of the following advantages. The described techniques may enable a UE to perform cell search procedures with greater efficiency and reduced latency, among other benefits. For example, if a UE is performing an initial access procedure in accordance with an unlicensed operating mode and the UE detects that a cell is operating in a licensed RF spectrum band, the UE may use different parameters (bandwidth, SCS, frequency offset) for the remainder of the initial access procedure, which may increase the likelihood of the UE successfully establishing a connection with a network entity via the cell. Moreover, the described techniques may increase the likelihood of the UE successfully receiving downlink messages from the network entity by enabling the UE to more accurately determine which resources are available for PDSCH resource mapping.

Aspects of the disclosure are initially described in the context of wireless communications systems, resource diagrams, and process flows. Aspects of the disclosure are further illustrated by and described with reference to apparatus diagrams, system diagrams, and flowcharts that relate to cell search procedures for licensed or shared RF spectrum bands.

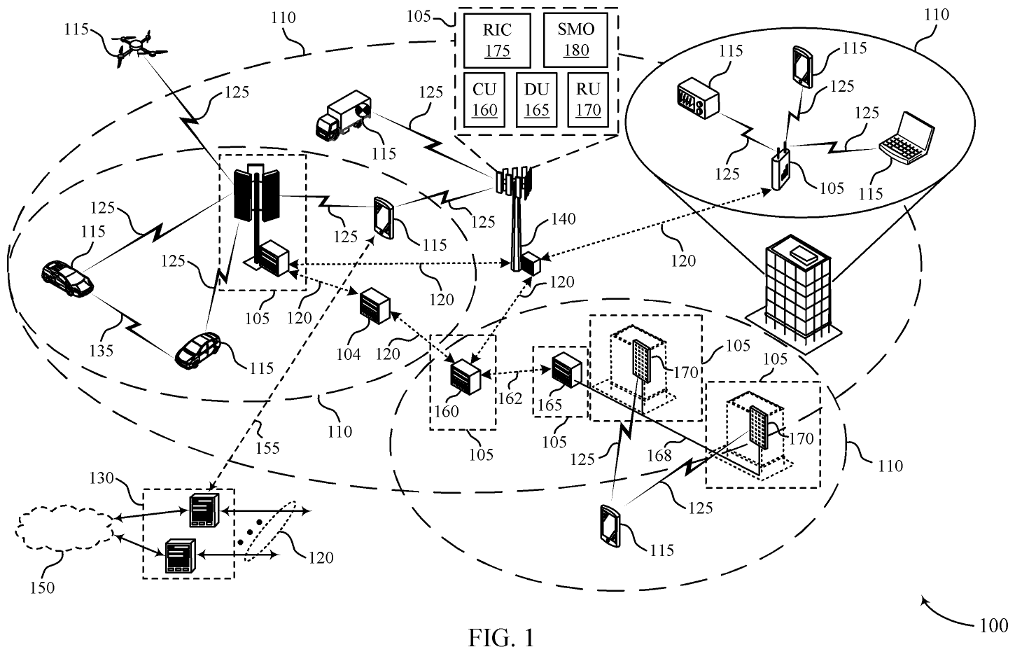

FIG. 1 illustrates an example of a wireless communications system 100 that supports cell search procedures for licensed or shared RF spectrum bands in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., an RF access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof.

An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)).

The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170).

In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor.

An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support cell search procedures for licensed or shared RF spectrum bands, as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink CCs and one or more uplink CCs according to a carrier aggregation configuration. Carrier aggregation may be used with both frequency division duplexing (FDD) and time division duplexing (TDD) CCs. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and SCS may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a SCS (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported SCS, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on SCS. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the SCS or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a CORESET) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple CCs.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 GHz. Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHZ, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with CCs operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some wireless communications systems, the 6 GHz RF spectrum band (which includes frequencies between 5.925 GHz and 7.125 GHZ) may be used for mobile service deployments. In some geographic regions, the entire 6 GHz RF spectrum band may be designated for unlicensed operations such as Wi-Fi or NR-U. In other geographic regions, the lower portion of the 6 GHz RF spectrum band (between 5.925 GHz and 6.425 GHz) may be designated (reserved) for unlicensed operations, while the higher portion of the 6 GHz RF spectrum band (between 6.425 GHz and 7.125 GHZ) may be designated for unlicensed operations or shared (unlicensed) operations. In other geographic regions, the entire 6 GHz RF spectrum band may be designated for licensed operations.

In accordance with the techniques described herein, a UE 115 may perform a cell search procedure to attach to a cell of a network entity 105. In some examples, if the UE 115 is unable to pre-determine an operating mode of the cell, the UE 115 may receive one or more system information messages via the cell using a first operating mode associated with a shared RF spectrum band. The one or more system information messages may indicate that the operating mode of the cell is either the first operating mode associated with the shared RF spectrum band or a second operating mode associated with a licensed RF spectrum band. Accordingly, the UE 115 may establish a connection with the network entity 105 via the cell using the operating mode indicated by the one or more system information messages.

Aspects of the wireless communications system 100 may be implemented to realize one or more of the following advantages. The techniques described with reference to FIG. 1 may enable a UE 115 to perform cell search procedures (in the 6 GHz RF spectrum band) with greater efficiency and reduced latency, among other benefits. For example, if a UE 115 is performing an initial access procedure in accordance with an unlicensed operating mode and the UE 115 detects that a cell is operating in a licensed RF spectrum band, the UE 115 may use different parameters (bandwidth, SCS, frequency offset) for the remainder of the initial access procedure, which may increase the likelihood of the UE 115 successfully establishing a connection with a network entity 105 via the cell. Moreover, the described techniques may increase the likelihood of the UE 115 successfully receiving downlink messages from the network entity 105 by enabling the UE 115 to more accurately determine which resources are available for PDSCH resource mapping.

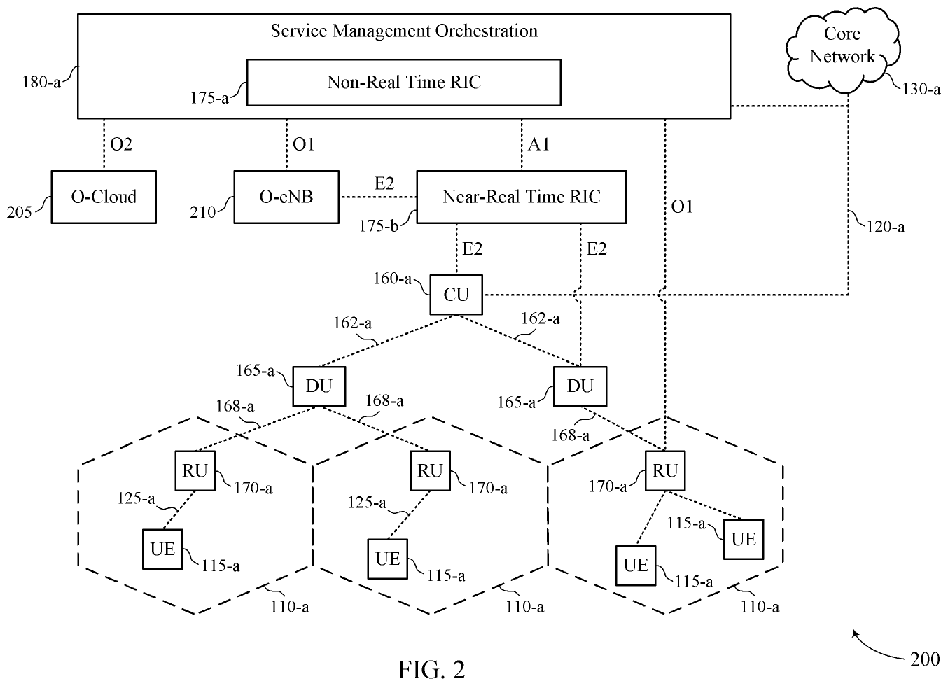

FIG. 2 illustrates an example of a network architecture 200 (e.g., a disaggregated base station architecture, a disaggregated RAN architecture) that supports cell search procedures for licensed or shared RF spectrum bands in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a, DUs 165-a, RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP, SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for forward error correction (FEC) encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a, RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via O1) or via generation of RAN management policies (e.g., A1 policies).

In accordance with examples disclosed herein, the UE 115-a may perform a cell search procedure to attach to a cell of a network entity (e.g., the RU 170-a). In some examples, if the UE 115-a is unable to pre-determine an operating mode of the cell, the UE 115-a may receive one or more system information messages via the cell using a first operating mode associated with a shared RF spectrum band. The one or more system information messages may indicate that the operating mode of the cell is either the first operating mode associated with the shared RF spectrum band or a second operating mode associated with a licensed RF spectrum band. Accordingly, the UE 115-a may establish a connection with the network entity via the cell using the operating mode indicated by the one or more system information messages.

Aspects of the network architecture 200 may be implemented to realize one or more of the following advantages. The techniques described with reference to FIG. 2 may enable the UE 115-a to perform cell search procedures (in the 6 GHz RF spectrum band) with greater efficiency and reduced latency, among other benefits. For example, if the UE 115-a is performing an initial access procedure in accordance with an unlicensed operating mode and the UE 115-a detects that a cell is operating in a licensed RF spectrum band, the UE 115-a may use different parameters (bandwidth, SCS, frequency offset) for the remainder of the initial access procedure, which may increase the likelihood of the UE 115-a successfully establishing a connection with a network entity (e.g., the RU 170-a) via the cell. Moreover, the described techniques may increase the likelihood of the UE 115-a successfully receiving downlink messages from the network entity by enabling the UE 115-a to more accurately determine which resources are available for PDSCH resource mapping.

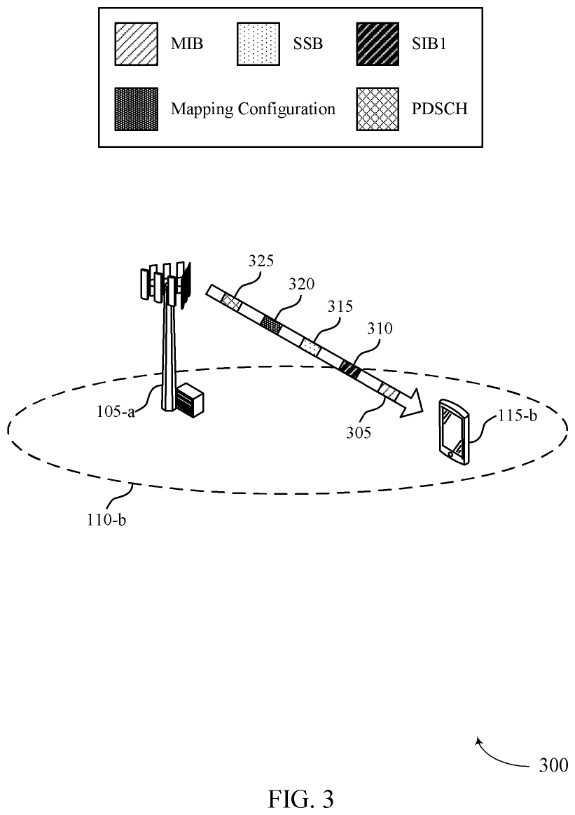

FIG. 3 illustrates an example of a wireless communications system 300 that supports cell search procedures for licensed or shared RF spectrum bands in accordance with one or more aspects of the present disclosure. The wireless communications system 300 may implement or be implemented by aspects of the wireless communications system 100 or the network architecture 200. For example, the wireless communications system 300 may include a network entity 105-a and a UE 115-b, which may be examples of corresponding devices described with reference to FIGS. 1 and 2. The network entity 105-a and the UE 115-b may communicate within a coverage area 110-b, which may be an example of the coverage area 110-a, as described with reference to FIG. 2.

In some wireless communications systems that support NR, licensed and unlicensed operations may be frequency band-dependent. Thus, the UE 115-b may be capable of determining whether an NR carrier is in a licensed or unlicensed spectrum based on pre-configured or predefined information. If the carrier (equivalently referred to as a cell, a CC, or a carrier frequency) is in a licensed spectrum, the UE 115-b may acquire SSB 315 and SIB1 310 in accordance with NR operating procedures. Otherwise, the UE 115-b may determine that SSB transmission is subject to LBT, and may acquire SSB 315 and SIB1 310 in accordance with NR-U operating procedures (which may result in a different interpretation of PBCH MIB).

If both licensed and unlicensed operations are supported for the 6 GHz band in different regions, the UE 115-b may be unable to determine which operating mode to use for a cell search procedure in the 6 GHz band. Initially, the UE 115-b may attempt using an unlicensed (NR-U) operating mode for the cell search procedure. If the initial attempt is unsuccessful and the UE 115-b is unable to decode MIB 305 or SIB1 310, the UE 115-b may switch to using a licensed NR operating mode for the cell search procedure. However, switching from an unlicensed NR-U operating mode to a licensed NR operating mode may increase the latency and power consumption associated with initial access procedures at the UE 115-b. If, for example, the UE 115-b can acquire location information via positioning techniques such as a global positioning system (GPS), the UE 115-b may use this information to select the appropriate operating mode to use for cell search and initial access. However, the UE 115-b may be unable to acquire accurate geographic information when the UE 115-b is indoors.

For initial cell search on a 6 GHz carrier in a licensed spectrum, the UE 115-b may use an unlicensed operating mode for reception of SSB 315 and SIB1 310. If, for example, SIB1 310 indicates that a cell is operating in a licensed spectrum, the UE 115-b may switched to a licensed NR operating mode. As such, the UE may monitor for SSB 315, CORESET #0, MIB 305, and SIB1 310 according to an unlicensed (NR-U) operating mode that is subject to LBT. However, upon reception of SIB1 310, the UE may switch to using a licensed operating mode and perform downlink reception and uplink transmission without gaining channel access.

In such examples, candidate SSB positioning mechanisms for unlicensed spectrum operations may be reused for a 6 GHz carrier in a licensed spectrum. For example, there may be up to 20 candidate SSB positions within 5 ms if a 30 KHz SCS is used or 10 candidate SSB positions within 5 ms if a 15 kHz SCS is used. SIB1 may also indicate whether all candidate SSB positions are used for SSB transmission (and thus unavailable for PDSCH resource mapping). In some examples, all candidate SSB positions corresponding to SSB indices provided by the ssb-PositionInBurst IE (e.g., candidate SSB positions that have a QCL relationship with the SSB indices) may be unavailable for PDSCH resource mapping (in accordance with NR-U operations). In other examples, for the one or more SSB indices provided by the ssb-PositionInBurst IE, the UE 115-b may determine that one SSB is transmitted per SSB index.

In some examples, the UE 115-b may receive an indication of a PDSCH resource mapping configuration 320 from the network entity 105-a. The PDSCH resource mapping configuration 320 may indicate one or more resources to use for reception of a PDSCH transmission 325, a PDSCH rate matching scheme to use for reception of the PDSCH transmission 325, one or more parameters to use for reception of the PDSCH transmission 325, etc. The UE 115-b may apply or otherwise interpret the PDSCH resource mapping configuration 320 according to the operating mode of a carrier supported by the network entity 105-a. For example, the UE 115-b may perform PDSCH rate matching around all candidate SSB positions or a subset of candidate SSB positions corresponding to SSB indices provided by the ssb-PositionInBurst IE in SIB1.

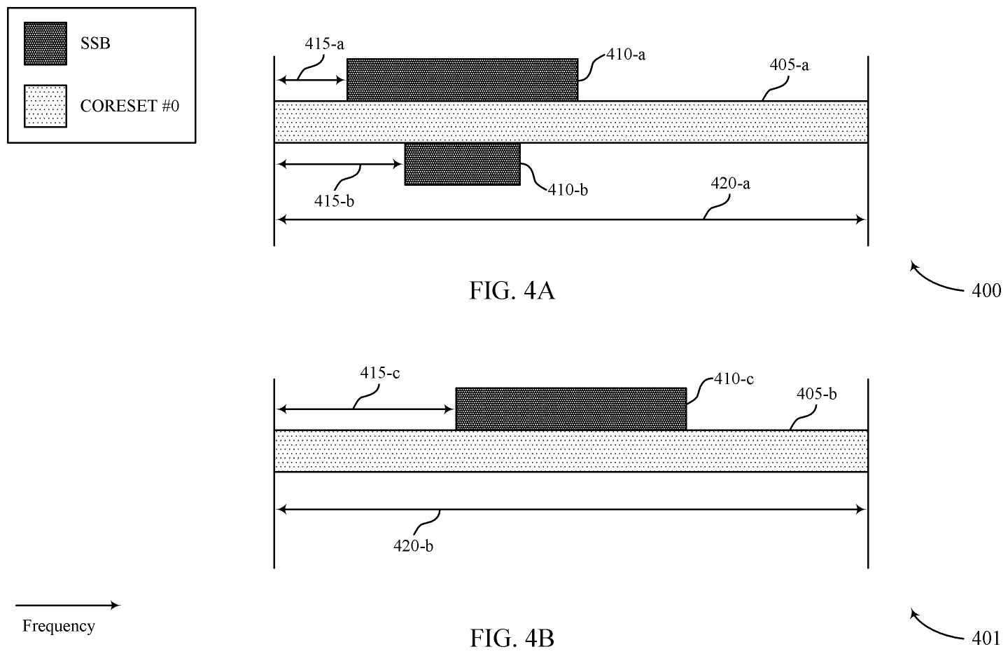

FIGS. 4A and 4B illustrate examples of a resource diagram 400 and a resource diagram 401 that support cell search procedures for licensed or shared RF spectrum bands in accordance with one or more aspects of the present disclosure. One or both of the resource diagram 400 or the resource diagram 401 may implement or be implemented by aspects of any of the wireless communications systems and network architectures described with reference to FIGS. 1 through 3. The resource diagram 400 illustrates an example of a resource configuration for an unlicensed (shared) RF spectrum band, while the resource diagram 401 illustrates an example of a resource configuration for a licensed RF spectrum band.

The resource diagram 400 may include SSB resources 410-a, SSB resources 410-b, and a CORESET 405-a (CORESET #0). The SSB resources 410-a may be associated with a 30 KHz SCS, while the SSB resources 410-b may be associated with a 15 KHz SCS. A frequency offset 415-a of 1, 2, or 3 resource blocks (RB) may be configured between a lowest RB in the CORESET 405-a and a lowest RB in the SSB resources 410-a. Similarly, a frequency offset 415-b of 10, 12, 14, or 16 RBs may be configured between the lowest RB in the CORESET 405-a and a lowest RB in the SSB resources 410-b. The CORESET 405-a may have a bandwidth 420-a of 48 RBs for a 30 KHz SCS or 96 RBs for a 15 kHz SCS. The resource diagram 401 may include SSB resources 410-c and a CORESET 405-b (CORESET #0). For a 30 kHz SCS, the CORESET 405-b may have a bandwidth 420-b of 48 or 96 RBs. For a 15 kHz SCS, the bandwidth 420-b of the CORESET 405-b may be configured as 24, 48, or 96 RBs. A frequency offset 415-c may be configured between a lowest RB in the SSB resources 410-c and a lowest RB in the CORESET 405-b.

In NR, PBCH may signal the SCS and configuration information for CORESET #0 (PDCCH for RMSI). A table with 16 entries may be used to indicate this configuration information in terms of bandwidth, time duration, and frequency offset. The CORESET bandwidth may be configured as 24, 48, or 96 RBs. The CORESET time duration may be configured as 1, 2, or 3 OFDM symbols. The frequency offset (in PRBs) may be calculated based on a difference between the lowest PRB in CORESET #0 and the lowest PRB in the SSB resources.

For NR-U, CORESET #0 may be configured with a bandwidth of 48 RBs for 30 KHz SCS and 96 RBs for 15 kHz SCS. The time duration of CORESET #0 may be configured as 1 or 2 OFDM symbols. For 30 kHz, the pddch-ConfigSIBI IE (listed in Table 1) may indicate RB-level offsets of 0, 1, 2, or 3. For 15 kHz SCS, the pddch-ConfigSIBI IE may indicate RB-level offsets of 10, 12, 14, or 16. The RB-level frequency offset for 15 kHz SCS (offset₁₅) is equivalent to 10+2*offset₃₀, where offset₃₀ indicates the RB-level frequency offset for 30 KHz SCS. As a result, CORESET #0 for 15 kHz SCS and 30 kHz SCS may effectively occupy the same frequency range. The SCS for all SSBs and CORESET #0 on a carrier may be the same for unlicensed NR operations. The ssbSubcarrierSpacingCommon bit of MIB (listed in Table 1) may be reinterpreted to indicate a value of Q.

The resource diagrams depicted in FIGS. 4A and 4B illustrate different CORESET #0 mappings for a first multiplexing pattern in FR1. For unlicensed or shared spectrum operations in FR1, the fields of subCarrierSpacingCommon and the least significant bit (LSB) of ssb-SubcarrierOffset (both of which are listed in Table 1) may be re-interpreted to indicate a value of Q (a QCL relation factor). Additionally, the RB offset value range for unlicensed NR operations may be different from licensed NR operations.

TABLE 1
Example MIB Payload for Licensed
and Unlicensed Spectrum in FR1

| IE | MIB | Description |
|---|---|---|
| systemFrameNum- | 6 | 6 most significant bits (MSB) of an SFN |
| ber | | |
| subCarrierSpac- | 1 | SCS for SIB1 and Msg2 or Msg 4 (licensed |
| ingCommon | | spectrum), which may be re-interpreted to |
| | | indicate the value of Q (unlicensed spectrum) |
| ssb- | 4 | Subcarrier offset between SSB and common |
| SubcarrierOffset | | RB. For unlicensed operation, the LSB is |
| | | used to indicate the value of Q |
| dmrs-TypeA- | 1 | Position of first demodulation reference |
| Position | | signal (DMRS) symbol in a slot |
| pdcch-ConfigSIB1 | 8 | Time and frequency location of CORESET |
| | | #0: 4 bits; physical downlink control channel |
| | | (PDCCH) monitoring occasions: 4 bits |
| cellBarred | 1 | Barred; not barred |
| intraFreqRe- | 1 | Cell selection or re-selection to intra- |
| selection | | frequency cells |
| Spare | 1 | Reserved bit for future use |
| Future extension | 1 | Bit for possible MIB extension |

In some examples, a future extension bit (e.g., BCCH-BCH-MessageType) or a spare bit in MIB (e.g., for FR1) may indicate an operating mode to use for reception of SSBs and SIB1. The BCCH-BCH-Message class is the set of RRC messages that may be sent from the network to a UE via a broadcast channel (BCH) transmission on the broadcast control channel (BCCH) logical channel. If a messageClassExtension field is set or the spare bit is set to 1, SSB resources and CORESET #0 may be configured according to a licensed operating mode. Otherwise, the SSB resources and CORESET #0 may be configured according to an unlicensed operating mode (NR-U).

For licensed operations, there may be a maximum of 8 SSB positions with a one-to-one mapping between SSB indices and PBCH DRMS sequences. The bandwidth of CORESET #0 may span 24, 48, or 96 PRBs. For unlicensed operations (NR-U), up to 20 candidate SSB positions may be configured within 5 ms when a 30 KHz SCS is used, and up to 10 candidate SSB positions may be configured within 5 ms when a 15 kHz SCS is used. The bandwidth of CORESET #0 may be fixed, and may span 48 PRBs for a 30 kHz SCS or 96 PRBs for a 15 kHz SCS.

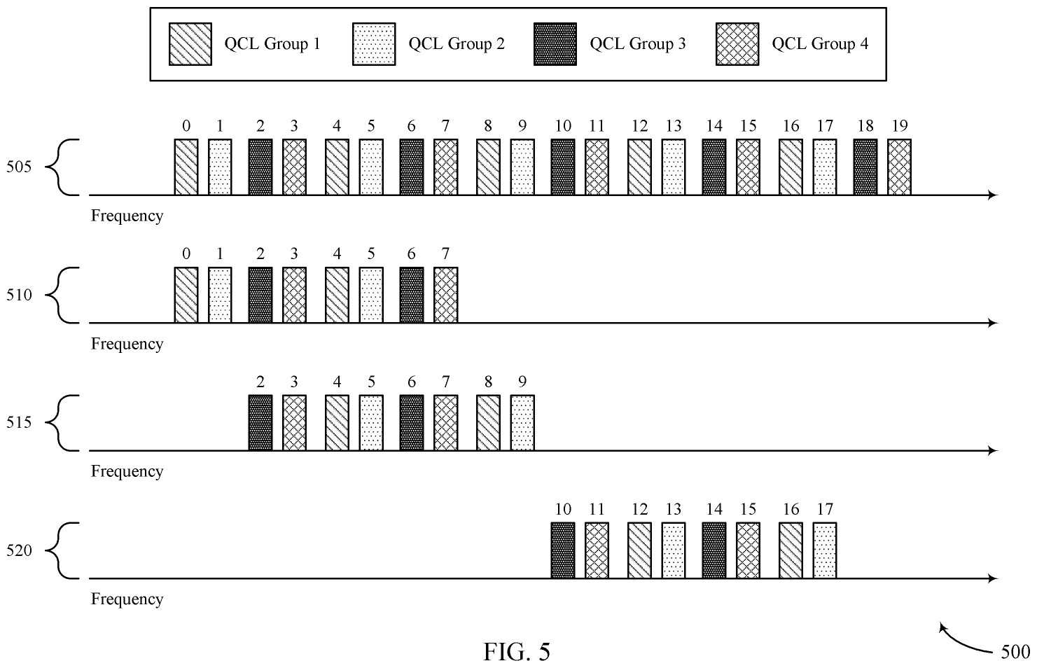

FIG. 5 illustrates an example of a resource diagram 500 that supports cell search procedures for licensed or shared RF spectrum bands in accordance with one or more aspects of the present disclosure. The resource diagram 500 may implement or be implemented by aspects of any of the wireless communications systems and resource diagrams described with reference to FIGS. 1 through 4. For example, the resource diagram 500 may include an SSB transmission scheme 505, an SSB transmission scheme 510, an SSB transmission scheme 515, and an SSB transmission scheme 520, which may be configured or otherwise determined by a UE 115 or a network entity 105, as described with reference to FIGS. 1 through 4.

For licensed NR operations, the maximum number of SSB indices available for transmission in a frequency band may be denoted by Lₘₐₓ. In FR1 frequency bands above 3 GHZ, Lₘₐₓ may be equal to 8. In such cases (when Lₘₐₓ=8), a UE may determine the 3 LSBs of an SSB index based on a one-to-one mapping with an index of a PBCH DMRS sequence. For unlicensed or shared spectrum operations, SSB transmission may be subject to LBT. To increase the likelihood of successful SSB transmission, unlicensed or shared operations may support the usage of candidate SSB positions. For example, within a half-frame of 5 ms, up to 20 SSB positions may be supported for a 30 kHz SCS, and up to 10 SSB positions may be supported for a 15 kHz SCS.

A QCL relation factor (denoted as Q) may also be used to indicate QCL relationships between SSB positions. For example, SSB positions that are Q positions apart may have a QCL relationship. If a network entity fails to transmit an SSB at a first position (x), the network entity may re-attempt transmission of the SSB at a corresponding position (x+Q). This QCL relation factor may have a value of 1, 2, 4, or 8, and may be signaled via MIB (for initial access) or dedicated RRC signaling (for RRM). For a UE, the quantity of SSB transmissions in a discovery reference signal (DRS) transmission window may be less than or equal to Q. An SSB index may be computed according to a candidate SSB position modulo Q. An SSB index may be detected using a combination of a PBCH DMRS sequence index (for 3 LSBs) and 1 or 2 bits in a PBCH payload (ā_{A+7} for 15 kHz SCS, and ā_{A+6} and ā_{A+7} for 30 kHz SCS).

The resource diagram 500 illustrates various SSB transmission schemes for NR cell search procedures. The SSB transmission schemes illustrated in the resource diagram 500 may correspond to an unlicensed operating mode (such as NR-U) with a QCL relation factor of 4 and an SCS of 30 kHz. For NR-U, after detecting an SSB (e.g., SSB 3) and decoding the QCL relation factor (Q) from a PBCH transmission, a UE may monitor a Type-0 PDCCH corresponding to all SSB positions (3, 7, 11, 15, and 19) that have a QCL relationship with the detected SSB. In contrast, for licensed NR operations, the UE may only monitor SSB position 3. In the SSB transmission scheme 505, all SSB positions (0 through 19) are planned for SSB transmissions. In the SSB transmission scheme 510, SSB positions 0 through 7 are used for SSB transmissions. In the SSB transmission scheme 515, SSB positions 2 through 9 are used for SSB transmissions. In the SSB transmission scheme 520, SSB positions 10 through 17 are used for SSB transmissions.

As described herein, one or more of the candidate SSB positions illustrated in the example of FIG. 5 may have a QCL relationship. For example, candidate SSB positions 0, 4, 8, 12, and 16 (QCL group 1) may have a first QCL relationship, candidate SSB positions 1, 5, 9, 13, and 17 (QCL group 2) may have a second QCL relationship, candidate SSB positions 2, 6, 10, 14, and 18 (QCL group 3) may have a third QCL relationship, and candidate SSB positions 3, 7, 11, 15, and 19 (QCL group 4) may have a fourth QCL relationship. Thus, if a UE is operating according to an unlicensed mode (for initial access) and the ssb-PositionInBurst IE (in SIB1) indicates that candidate SSB position 2 is used for SSB transmission, the UE may monitor other candidate SSB positions in QCL group 3 (SSB positions 6, 10, 14, and 18) as well as candidate SSB position 2, as these candidate SSB positions have a QCL relationship.

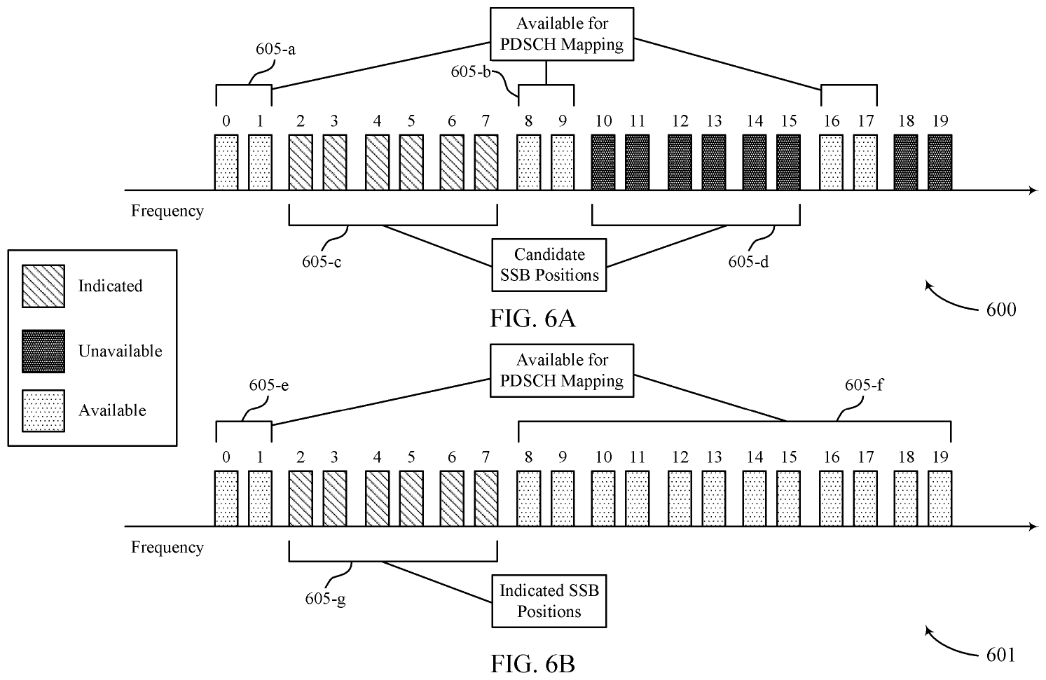

FIGS. 6A and 6B illustrate examples of a resource diagram 600 and a resource diagram 601 that support cell search procedures for licensed or shared RF spectrum bands in accordance with one or more aspects of the present disclosure. One or both of the resource diagram 600 or the resource diagram 601 may implement or be implemented by aspects of any of the resource diagrams and wireless communications systems described with reference to FIGS. 1 through 5. For example, the resource diagram 600 and the resource diagram 601 may illustrate downlink rate matching schemes, which may be implemented or otherwise configured by a UE 115 or a network entity 105, as described with reference to FIGS. 1 through 5.

As described herein, up to 20 candidate SSB positions may be supported for a SCS of 30 kHz, and up to 10 candidate SSB positions may be supported for a SCS of 15 kHz. Thus, although 20 candidate SSB positions are depicted in the resource diagram 600 and the resource diagram 601, it is to be understood that the techniques and operations described with reference to FIGS. 6A and 6B are applicable to different SCS configurations (15 kHz, 30 kHz) and different SSB resource configurations (10 candidate SSB positions, 20 candidate SSB positions). The resource diagram 600 and the resource diagram 601 may illustrate examples of PDSCH resource mapping schemes with a QCL relation factor (Q) of 8 when the ssb-PositionInBurstIE indicates that SSB index 0 and SSB index 1 are not used for SSB transmissions.

In the resource diagram 600, a UE may receive one or more system information messages (MIB or SIB1) by monitoring a carrier in a 6 GHz RF spectrum band. The one or more system information messages may indicate whether the carrier is associated with a licensed RF spectrum band or a shared RF spectrum band. The one or more system information messages may also indicate one or more SSB indices corresponding to candidate SSB resources 605-c that are used for transmission of one or more SSBs. As illustrated in the example of FIG. 6A, the candidate SSB resources 605-c may correspond to SSB indices 2 through 7. The UE may determine that candidate SSB resources 605-a are not used for transmission of the one or more SSBs, as the SSB indices corresponding to the candidate SSB resources 605-a (0 and 1) are not indicated by the second system information.

If the UE determines that the carrier is in a shared (unlicensed) RF spectrum band (e.g., based on an indication in MIB or SIB1), the UE may identify candidate SSB resources 605-d that have a QCL relationship with the candidate SSB resources 605-c, and may determine that the candidate SSB resources 605-d (as well as the candidate SSB resources 605-c) are unavailable for PDSCH resource mapping. Likewise, the UE may identify a QCL relationship between the candidate SSB resources 605-a and candidate SSB resources 605-b (corresponding to SSB indices 8 and 9), and may determine that these resources are available for PDSCH rate matching (as these resources are not used for SSB transmission).

In the resource diagram 601, the UE may determine that the carrier is in a licensed RF spectrum based on an indication in MIB or SIB1. Accordingly, the UE may switch to a licensed operating mode (if the UE was previously operating according to an unlicensed mode) and use corresponding parameters (bandwidths, time durations, frequency offsets) for cell search and acquisition. The UE may also receive an indication of SSB indices (2 through 7) corresponding to candidate SSB resources 605-g used for transmission of one or more SSBs. The UE may determine that candidate SSB resources 605-e are not used for SSB transmission if SSB indices corresponding to the candidate SSB resources 605-e (0 and 1) are not indicated.

The UE may perform PDSCH rate matching based on the one or more system information messages, the operating mode of the carrier (licensed or shared), a PDSCH resource mapping configuration provided by the network, or any combination thereof. For example, the UE may determine that only one SSB is transmitted for each of the SSB indices indicated by the one or more information messages (in accordance a licensed spectrum operating mode). Accordingly, the UE may determine that candidate SSB resources 605-f (corresponding to SSB indices 8 through 19) are available for PDSCH resource mapping. Thus, in some examples, the UE may receive a downlink message (e.g., a PDSCH transmission) from the network via one or both of the candidate SSB resources 605-e or the candidate SSB resources 605-f.

The techniques and operations described with reference to FIGS. 6A and 6B may support enhanced PDSCH resource mapping for licensed carriers. For example, the UE may either use an NR-U approach (depicted in the resource diagram 600) or a licensed NR approach (depicted in the resource diagram 601) for PDSCH mapping when the UE receives an indication (via SIB1) that the carrier is in a licensed RF spectrum. Using an NR-U approach (described with reference to FIG. 6B) for a licensed carrier may enable the UE to combine SSBs across all QCL-ed candidate SSB positions during cell search processes, which may improve the performance of such processes.

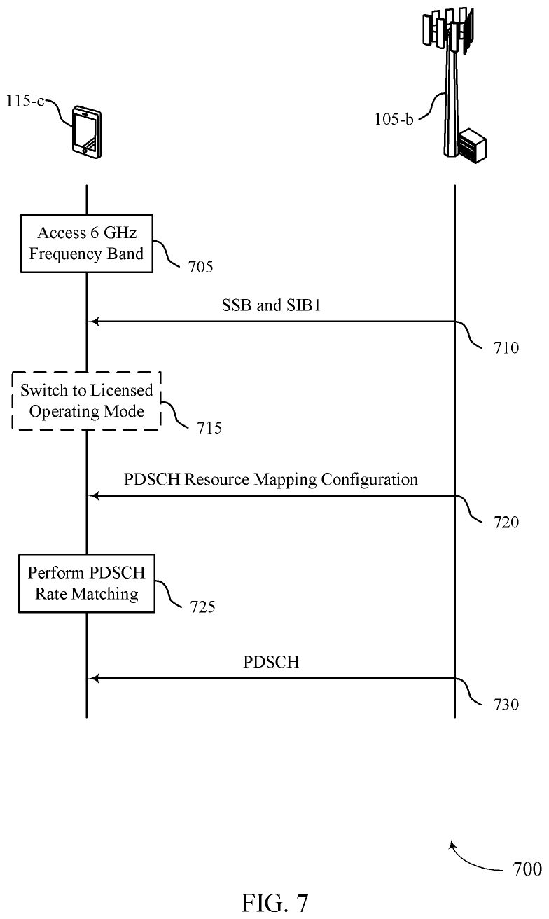

FIG. 7 illustrates an example of a process flow 700 that supports cell search procedures for licensed or shared RF spectrum bands in accordance with one or more aspects of the present disclosure. The process flow 700 may implement or be implemented by aspects of any of the wireless communications systems, network architectures, or resource diagrams described with reference to FIGS. 1 through 6. For example, the process flow 700 may include a UE 115-c and a network entity 105-b, which may be examples of corresponding devices described with reference to FIGS. 1 through 6. In the following description of the process flow 700, operations between the UE 115-c and the network entity 105-b may be added, omitted, or performed in a different order (with respect to the exemplary order shown).

At 705, the UE 115-c may access a carrier in a 6 GHz RF spectrum band, where an operating mode of the carrier is unknown to the UE 115-c. At 710, the UE 115-c may receive one or more SSBs from the network entity 105-b in accordance with an unlicensed operating mode (e.g., a first operating mode associated with a shared RF spectrum band) based on monitoring the carrier in the 6 GHZ RF spectrum band. The UE 115-c may also receive one or more system information messages (e.g., SIB1) from the network entity 105-b via the carrier. The one or more system information messages may indicate whether the carrier is associated with a licensed RF spectrum band or a shared (unlicensed) RF spectrum band. The one or more system information messages may also indicate a first set of resources (SSB indices) of multiple candidate resources (also referred to as candidate SSB positions) available for SSB transmissions.

At 715, the UE 115-c may switch to a licensed operating mode (e.g., a second operating mode associated with a licensed RF spectrum band) if the one or more system information messages indicate that the carrier of the network entity 105-b is operating in a licensed spectrum. Alternatively, if the UE 115-c detects that the carrier is in a shared RF spectrum band, the UE 115-c may continue accessing the carrier according to the unlicensed operating mode. If, for example, the operating mode of the carrier is signaled via MIB (a MIB-based mode indication), the UE 115-c may use SSB and CORESET parameters that correspond to the operating mode indicated by the MIB. Alternatively, if the operating mode of the carrier is signaled via SIB (a SIB-based mode indication), the UE 115-c may use SSB and CORESET parameters that correspond to an NR-U operating mode.

If, for example, the UE 115-c determines that the carrier is in a shared RF spectrum band (that is subject to LBT), the UE 115-c may identify other candidate resources that have a QCL relationship with the first set of resources, and may determine that these candidate resources are unavailable for PDSCH resource mapping. Alternatively, if the UE 115-c determines that the carrier is operating in a licensed RF spectrum band, the UE 115-c may receive an indication of a PDSCH resource mapping configuration from the network entity 105-b at 720. At 725, the UE 115-c may perform PDSCH rate matching according to the PDSCH resource mapping configuration provided by the network entity 105-b.

At 730, the UE 115-c may receive a downlink message (e.g., a PDSCH transmission) from the network entity 105-b via a second set of resources of the multiple candidate resources that are available for SSB transmissions. The UE 115-c may identify the second set of resources based on the operating mode of the carrier and the SSB indices provided by the one or more system information messages. The UE 115-c may either use an NR-U approach (as described with reference to FIG. 6A) or a licensed NR approach (as described with reference to FIG. 6B) for PDSCH mapping when the UE receives an indication (via SIB1) that the carrier is in a licensed RF spectrum. Using an NR-U approach for licensed carriers may enable the UE 115-c to combine SSBs across all QCL-ed candidate SSB positions during cell search processes, which may improve the performance of such processes.

Aspects of the process flow 700 may be implemented to realize one or more of the following advantages. The techniques described with reference to FIG. 7 may enable the UE 115-c to perform cell search procedures (in the 6 GHz RF spectrum band) with greater efficiency and reduced latency, among other benefits. For example, if the UE 115-c is performing an initial access procedure in accordance with an unlicensed operating mode and the UE 115-c detects that a carrier of the network entity 105-b is in a licensed RF spectrum band, the UE 115-c may use different parameters (bandwidths, SCSs, frequency offsets) for the remainder of the initial access procedure, which may increase the likelihood of the UE 115-c successfully establishing a connection with the network entity 105-b. Moreover, the described techniques may increase the likelihood of the UE 115-c successfully receiving downlink messages from the network entity 105-b by enabling the UE 115-c to more accurately determine which resources are available for PDSCH resource mapping.

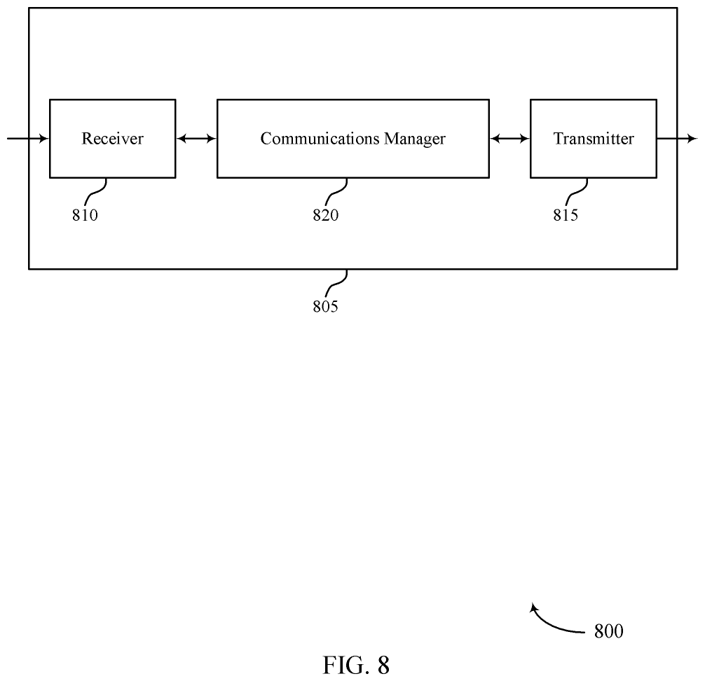

FIG. 8 shows a block diagram 800 of a device 805 that supports cell search procedures for licensed or shared RF spectrum bands in accordance with one or more aspects of the present disclosure. The device 805 may be an example of aspects of a UE 115, as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to cell search procedures for licensed or shared RF spectrum bands). Information may be passed on to other components of the device 805. The receiver 810 may utilize a single antenna or multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to cell search procedures for licensed or shared RF spectrum bands). In some examples, the transmitter 815 may be co-located with a receiver 810 in a transceiver module. The transmitter 815 may utilize a single antenna or multiple antennas.

The communications manager 820, the receiver 810, the transmitter 815, or various combinations thereof or various components thereof may be examples of means for performing various aspects of cell search procedures for licensed or shared RF spectrum bands, as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations, as described herein.

The communications manager 820 may support wireless communication at a UE (e.g., the device 805) in accordance with examples disclosed herein. For example, the communications manager 820 may be configured as or otherwise support a means for performing a cell search procedure to attach to a cell of a network entity, where an operating mode of the cell is unknown to the UE. The communications manager 820 may be configured as or otherwise support a means for receiving one or more system information messages via the cell using a first operating mode associated with a shared RF spectrum band based on the operating mode of the cell being unknown to the UE, the one or more system information messages indicating that the operating mode of the cell is either the first operating mode associated with the shared RF spectrum band or a second operating mode associated with a licensed RF spectrum band. The communications manager 820 may be configured as or otherwise support a means for establishing a connection with the network entity via the cell using the operating mode indicated by the one or more system information messages.

By including or configuring the communications manager 820 in accordance with examples, as described herein, the device 805 (e.g., a processor controlling or otherwise coupled with the receiver 810, the transmitter 815, the communications manager 820, or a combination thereof) may support techniques for reduced power consumption by reducing the number of unsuccessful cell search procedures performed by the device 805. For example, the techniques described herein may enable the device 805 to determine whether a cell is operating in a licensed or unlicensed (shared) RF spectrum band, which may improve the likelihood of the device 805 successfully connecting to the cell.

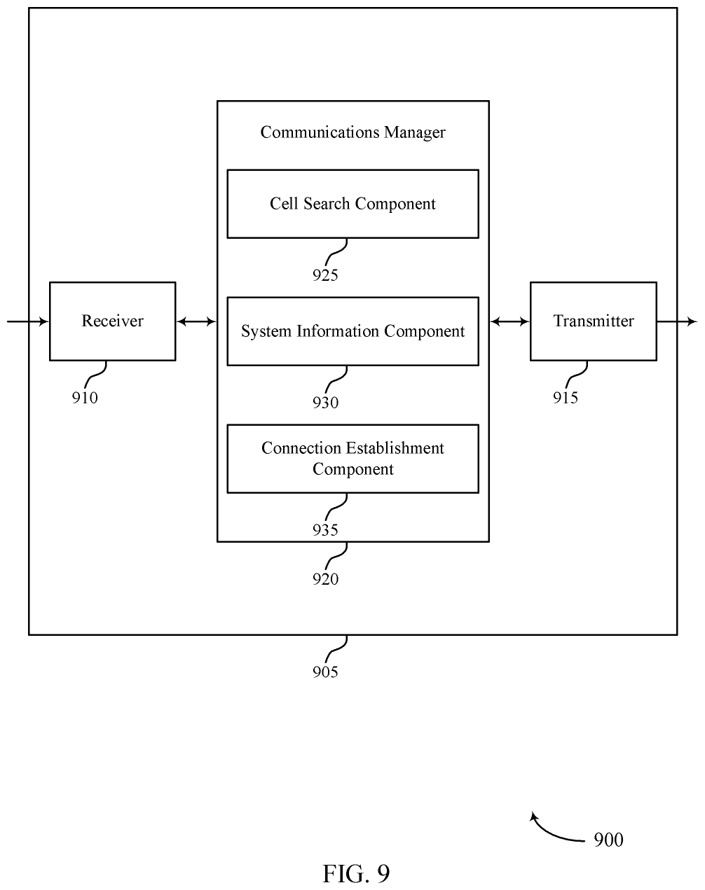

FIG. 9 shows a block diagram 900 of a device 905 that supports cell search procedures for licensed or shared RF spectrum bands in accordance with one or more aspects of the present disclosure. The device 905 may be an example of aspects of a device 805 or a UE 115, as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to cell search procedures for licensed or shared RF spectrum bands). Information may be passed on to other components of the device 905. The receiver 910 may utilize a single antenna or multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to cell search procedures for licensed or shared RF spectrum bands). In some examples, the transmitter 915 may be co-located with a receiver 910 in a transceiver module. The transmitter 915 may utilize a single antenna or multiple antennas.

The device 905, or various components thereof, may be an example of means for performing various aspects of cell search procedures for licensed or shared RF spectrum bands, as described herein. For example, the communications manager 920 may include a cell search component 925, a system information component 930, a connection establishment component 935, or any combination thereof. The communications manager 920 may be an example of aspects of a communications manager 820, as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations, as described herein.

The communications manager 920 may support wireless communication at a UE (e.g., the device 905) in accordance with examples disclosed herein. The cell search component 925 may be configured as or otherwise support a means for performing a cell search procedure to attach to a cell of a network entity, where an operating mode of the cell is unknown to the UE. The system information component 930 may be configured as or otherwise support a means for receiving one or more system information messages via the cell using a first operating mode associated with a shared RF spectrum band based on the operating mode of the cell being unknown to the UE, the one or more system information messages indicating that the operating mode of the cell is either the first operating mode associated with the shared RF spectrum band or a second operating mode associated with a licensed RF spectrum band. The connection establishment component 935 may be configured as or otherwise support a means for establishing a connection with the network entity via the cell using the operating mode indicated by the one or more system information messages.

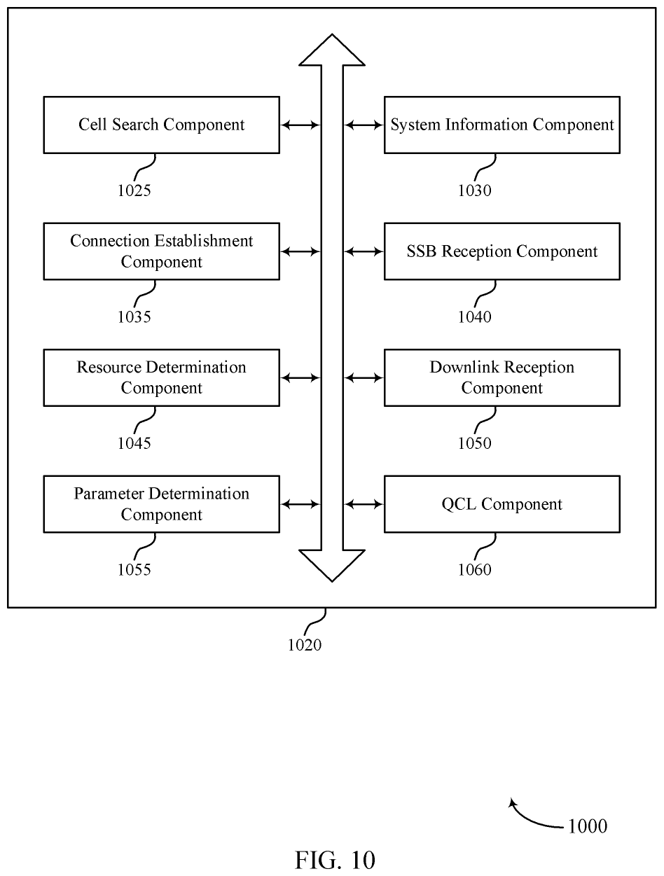

FIG. 10 shows a block diagram 1000 of a communications manager 1020 that supports cell search procedures for licensed or shared RF spectrum bands in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of cell search procedures for licensed or shared RF spectrum bands, as described herein. For example, the communications manager 1020 may include a cell search component 1025, a system information component 1030, a connection establishment component 1035, an SSB reception component 1040, a resource determination component 1045, a downlink reception component 1050, a parameter determination component 1055, a QCL component 1060, or any combination thereof. Each of these components may communicate, directly or indirectly, with one another (e.g., via one or more buses).

The communications manager 1020 may support wireless communication at a UE in accordance with examples disclosed herein. The cell search component 1025 may be configured as or otherwise support a means for performing a cell search procedure to attach to a cell of a network entity, where an operating mode of the cell is unknown to the UE. The system information component 1030 may be configured as or otherwise support a means for receiving one or more system information messages via the cell using a first operating mode associated with a shared RF spectrum band based on the operating mode of the cell being unknown to the UE, the one or more system information messages indicating that the operating mode of the cell is either the first operating mode associated with the shared RF spectrum band or a second operating mode associated with a licensed RF spectrum band. The connection establishment component 1035 may be configured as or otherwise support a means for establishing a connection with the network entity via the cell using the operating mode indicated by the one or more system information messages.

In some examples, to support receiving the one or more system information messages, the system information component 1030 may be configured as or otherwise support a means for receiving, via the cell and in accordance with the cell search procedure, a MIB including one or more bits that indicate an operating mode to use for reception of one or more SIBs and SSBs, the operating mode including either the first operating mode or the second operating mode.

In some examples, the parameter determination component 1055 may be configured as or otherwise support a means for determining one or more of a SCS, a bandwidth, a maximum quantity of candidate resources available for transmission of SSBs, a frequency offset, or a time duration to use for reception of the one or more SIBs and SSBs based on the operating mode of the cell.

In some examples, the MIB that indicates one or more of an SFN, a common SCS, a SSB subcarrier offset, a DMRS position field, a downlink control channel resource configuration, a CORESET configuration, a cell barring parameter, or an intra-frequency reselection parameter for the cell search procedure. In some examples, one or both of a spare bit or a future extension bit in the MIB indicate the operating mode of the cell.

In some examples, to support receiving the one or more system information messages, the SSB reception component 1040 may be configured as or otherwise support a means for monitoring a set of SSB resources and a CORESET in accordance with the first operating mode associated with the shared RF spectrum band.

In some examples, to support receiving the one or more system information messages, the SSB reception component 1040 may be configured as or otherwise support a means for receiving one or more SSBs via the set of SSB resources.

In some examples, to support receiving the one or more system information messages, the system information component 1030 may be configured as or otherwise support a means for receiving, via the CORESET, a first SIB indicating that the cell is operating in either the licensed RF spectrum band or the shared RF spectrum band.

In some examples, to support receiving the first SIB, the system information component 1030 may be configured as or otherwise support a means for monitor the CORESET using one or more of a SCS, a bandwidth, an RB offset, or a time duration associated with the first operating mode.

In some examples, to support receiving the one or more system information messages, the system information component 1030 may be configured as or otherwise support a means for receiving, via the cell and in accordance with the cell search procedure, a SIB including an information element (IE) that indicates a first set of SSB indices corresponding to a first set of resources of multiple candidate resources used for transmission of SSBs.

In some examples, a first system information message of the one or more system information messages indicates that the cell is using the second operating mode associated with the licensed RF spectrum band. In some examples, a second system information message of the one or more system information messages indicates a first set of resources of multiple candidate resources used for transmission of SSBs.

In some examples, the resource determination component 1045 may be configured as or otherwise support a means for determining whether a second set of resources of the multiple candidate resources is available for downlink shared channel resource mapping based on the second operating mode of the cell and a QCL relationship between the first set of resources and the second set of resources. In some examples, the downlink reception component 1050 may be configured as or otherwise support a means for monitoring for a downlink message in accordance with the downlink shared channel resource mapping.

In some examples, the QCL component 1060 may be configured as or otherwise support a means for identifying a QCL relationship between the first set of resources and a second set of resources of the multiple candidate resources based on a set of SSB indices associated with the first set of resources and a QCL parameter indicated by a MIB or a dedicated RRC message.

In some examples, the SSB reception component 1040 may be configured as or otherwise support a means for receiving an indication of a first set of resources of multiple candidate resources used for transmission of SSBs. In some examples, the resource determination component 1045 may be configured as or otherwise support a means for determining that all of the multiple candidate resources except the first set of resources are available for downlink shared channel resource mapping based on the one or more system information messages indicating that the cell is operating in the licensed RF spectrum band. In some examples, the downlink reception component 1050 may be configured as or otherwise support a means for monitoring for a downlink message in accordance with the downlink shared channel resource mapping.

In some examples, to support receiving the one or more system information messages, the system information component 1030 may be configured as or otherwise support a means for receiving, via the cell and in accordance with the cell search procedure, a first system information message indicating a first set of resources of multiple candidate resources used for transmission of SSBs.

In some examples, the downlink reception component 1050 may be configured as or otherwise support a means for receive a downlink message via a second set of resources of the multiple candidate resources based on the first system information message, where the second set of resources is determined according to the operating mode of the cell.

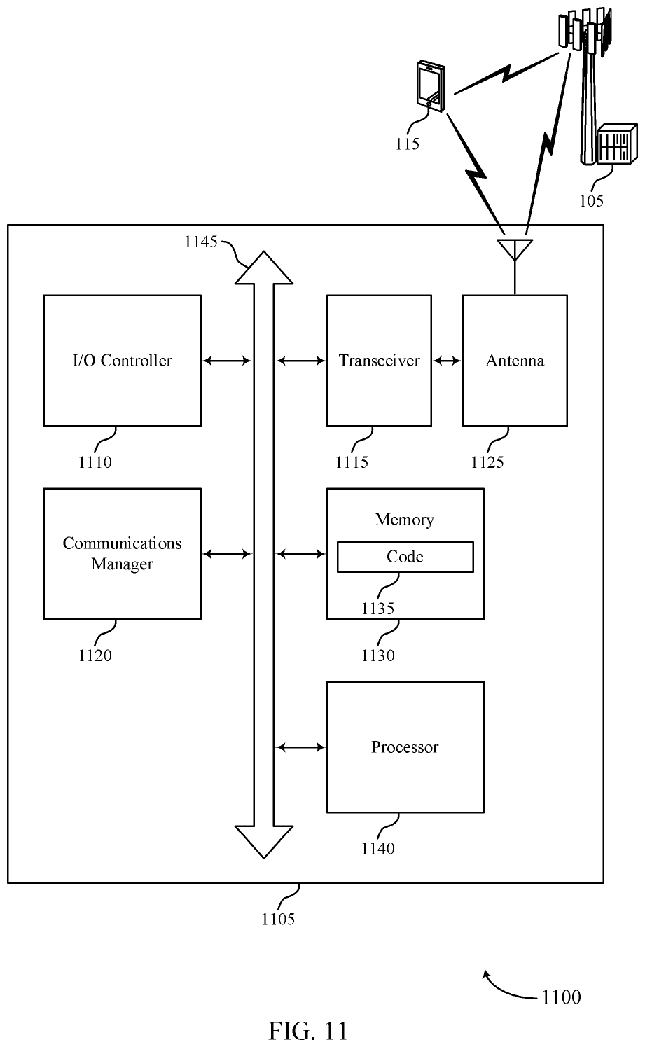

FIG. 11 shows a diagram of a system 1100 including a device 1105 that supports cell search procedures for licensed or shared RF spectrum bands in accordance with one or more aspects of the present disclosure. The device 1105 may be an example of or include the components of a device 805, a device 905, or a UE 115, as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOSR, ANDROIDR, MS-DOSR, MS-WINDOWS®, OS/2R, UNIXR, LINUXR, or another known operating system. Additionally or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links, as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting cell search procedures for licensed or shared RF spectrum bands). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at a UE (e.g., the device 1105) in accordance with examples disclosed herein. For example, the communications manager 1120 may be configured as or otherwise support a means for performing a cell search procedure to attach to a cell of a network entity, where an operating mode of the cell is unknown to the UE. The communications manager 1120 may be configured as or otherwise support a means for receiving one or more system information messages via the cell using a first operating mode associated with a shared RF spectrum band based on the operating mode of the cell being unknown to the UE, the one or more system information messages indicating that the operating mode of the cell is either the first operating mode associated with the shared RF spectrum band or a second operating mode associated with a licensed RF spectrum band. The communications manager 1120 may be configured as or otherwise support a means for establishing a connection with the network entity via the cell using the operating mode indicated by the one or more system information messages.

By including or configuring the communications manager 1120 in accordance with examples, as described herein, the device 1105 may support techniques for performing cell search procedures with greater efficiency and reduced latency, among other benefits. For example, if the device 1105 is performing an initial access procedure in accordance with an unlicensed operating mode and the device 1105 detects that a cell is operating in a licensed RF spectrum band, the device 1105 may use different parameters (bandwidth, SCS, frequency offset) for the remainder of the initial access procedure, which may increase the likelihood of the device 1105 successfully establishing a connection with a network entity via the cell. Moreover, the described techniques may increase the likelihood of the device 1105 successfully receiving downlink messages from the network entity by enabling the device 1105 to more accurately determine which resources are available for PDSCH resource mapping.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of cell search procedures for licensed or shared RF spectrum bands, as described herein, or the processor 1140 and the memory 1130 may be otherwise configured to perform or support such operations.

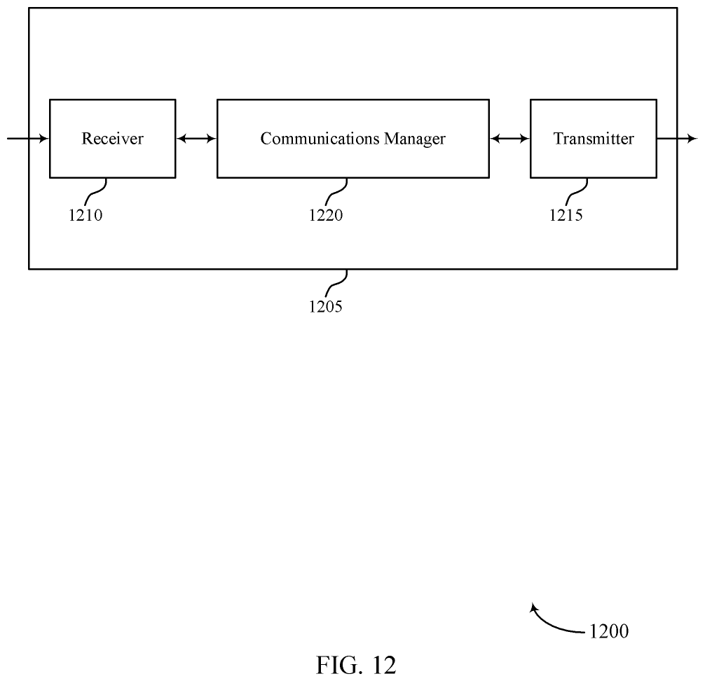

FIG. 12 shows a block diagram 1200 of a device 1205 that supports cell search procedures for licensed or shared RF spectrum bands in accordance with one or more aspects of the present disclosure. The device 1205 may be an example of aspects of a network entity 105, as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of cell search procedures for licensed or shared RF spectrum bands, as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations, as described herein.

The communications manager 1220 may support wireless communication at a network entity (e.g., the device 1205) in accordance with examples disclosed herein. For example, the communications manager 1220 may be configured as or otherwise support a means for performing a cell search procedure in accordance with an operating mode of a cell of the network entity, where the operating mode of the cell is unknown to a UE. The communications manager 1220 may be configured as or otherwise support a means for outputting, via the cell and in accordance with the cell search procedure, one or more system information messages indicating that the operating mode of the cell is either a first operating mode associated with a shared RF spectrum band or a second operating mode associated with a licensed RF spectrum band. The communications manager 1220 may be configured as or otherwise support a means for establishing a connection with the UE via the cell using the operating mode indicated by the one or more system information messages.

By including or configuring the communications manager 1220 in accordance with examples, as described herein, the device 1205 (e.g., a processor controlling or otherwise coupled with the receiver 1210, the transmitter 1215, the communications manager 1220, or a combination thereof) may support techniques for reduced power consumption by reducing the number of unsuccessful cell search procedures performed by a UE. For example, the techniques described herein may enable a UE to determine whether the device 1205 is operating in a licensed or unlicensed (shared) RF spectrum band, which may improve the likelihood of the UE establishing a connection with the device 1205.

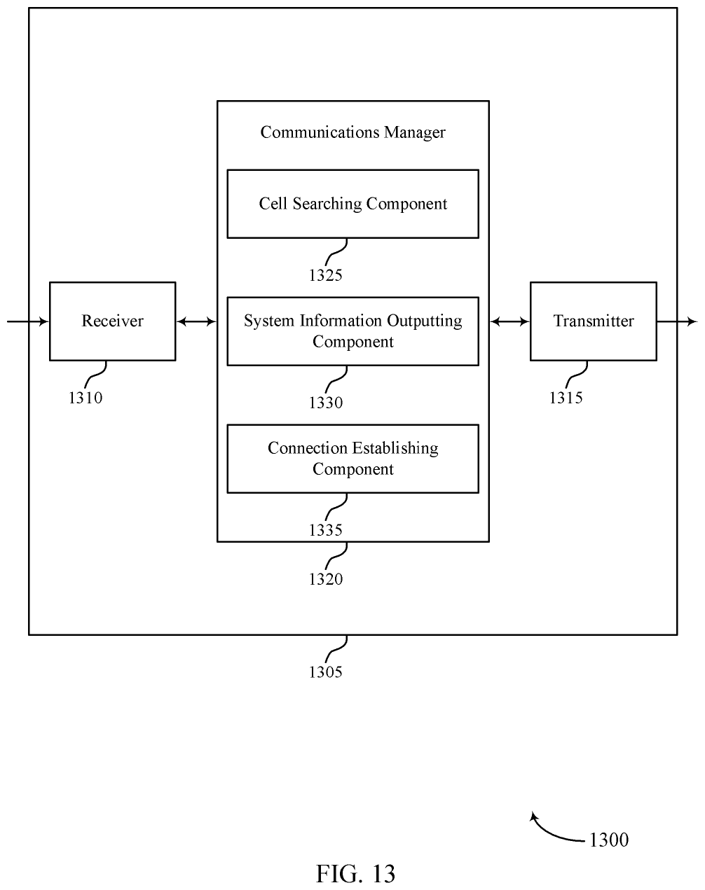

FIG. 13 shows a block diagram 1300 of a device 1305 that supports cell search procedures for licensed or shared RF spectrum bands in accordance with one or more aspects of the present disclosure. The device 1305 may be an example of aspects of a device 1205 or a network entity 105, as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of cell search procedures for licensed or shared RF spectrum bands, as described herein. For example, the communications manager 1320 may include a cell searching component 1325, a system information outputting component 1330, a connection establishing component 1335, or any combination thereof. The communications manager 1320 may be an example of aspects of a communications manager 1220, as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations, as described herein.

The communications manager 1320 may support wireless communication at a network entity (e.g., the device 1305) in accordance with examples disclosed herein. The cell searching component 1325 may be configured as or otherwise support a means for performing a cell search procedure in accordance with an operating mode of a cell of the network entity, where the operating mode of the cell is unknown to a UE. The system information outputting component 1330 may be configured as or otherwise support a means for outputting, via the cell and in accordance with the cell search procedure, one or more system information messages indicating that the operating mode of the cell is either a first operating mode associated with a shared RF spectrum band or a second operating mode associated with a licensed RF spectrum band. The connection establishing component 1335 may be configured as or otherwise support a means for establishing a connection with the UE via the cell using the operating mode indicated by the one or more system information messages.

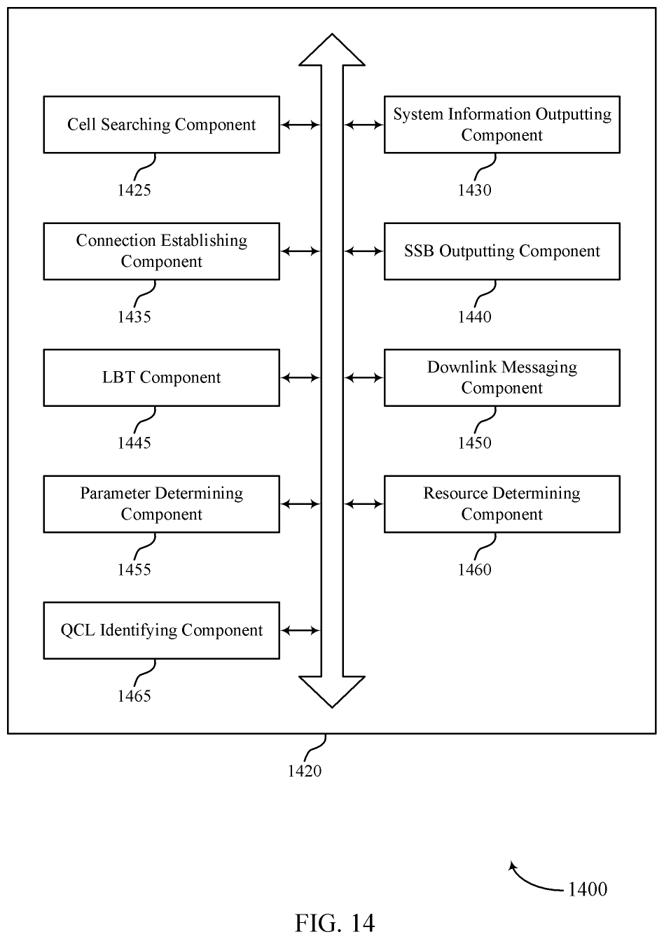

FIG. 14 shows a block diagram 1400 of a communications manager 1420 that supports cell search procedures for licensed or shared RF spectrum bands in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of cell search procedures for licensed or shared RF spectrum bands, as described herein. For example, the communications manager 1420 may include a cell searching component 1425, a system information outputting component 1430, a connection establishing component 1435, an SSB outputting component 1440, an LBT component 1445, a downlink messaging component 1450, a parameter determining component 1455, a resource determining component 1460, a QCL identifying component 1465, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communication at a network entity in accordance with examples disclosed herein. The cell searching component 1425 may be configured as or otherwise support a means for performing a cell search procedure in accordance with an operating mode of a cell of the network entity, where the operating mode of the cell is unknown to a UE. The system information outputting component 1430 may be configured as or otherwise support a means for outputting, via the cell and in accordance with the cell search procedure, one or more system information messages indicating that the operating mode of the cell is either a first operating mode associated with a shared RF spectrum band or a second operating mode associated with a licensed RF spectrum band. The connection establishing component 1435 may be configured as or otherwise support a means for establishing a connection with the UE via the cell using the operating mode indicated by the one or more system information messages.

In some examples, to support outputting the one or more system information messages, the system information outputting component 1430 may be configured as or otherwise support a means for outputting, via the cell and in accordance with the cell search procedure, a MIB including one or more bits that indicate an operating mode to use for reception of one or more SIBs and SSBs, the operating mode including either the first operating mode or the second operating mode.

In some examples, the parameter determining component 1455 may be configured as or otherwise support a means for determining one or more of a SCS, a bandwidth, a maximum quantity of candidate resources available for transmission of SSBs, a frequency offset, or a time duration to use for transmission of the one or more SIBs and SSBs based on the operating mode of the cell.

In some examples, the MIB that indicates one or more of an SFN, a common SCS, a SSB subcarrier offset, a DMRS position field, a downlink control channel resource configuration, a CORESET configuration, a cell barring parameter, or an intra-frequency reselection parameter for the cell search procedure. In some examples, one or both of a spare bit or a future extension bit in the MIB indicate the operating mode of the cell.

In some examples, to support outputting the one or more system information messages, the SSB outputting component 1440 may be configured as or otherwise support a means for outputting one or more SSBs via a set of SSB resources. In some examples, to support outputting the one or more system information messages, the system information outputting component 1430 may be configured as or otherwise support a means for outputting, via a CORESET, a first SIB indicating that the cell is operating in either the licensed RF spectrum band or the shared RF spectrum band.

In some examples, to support outputting the first SIB, the system information outputting component 1430 may be configured as or otherwise support a means for outputting the first SIB via the CORESET using one or more of a SCS, a bandwidth, an RB offset, or a time duration associated with the first operating mode.

In some examples, to support outputting the one or more system information messages, the system information outputting component 1430 may be configured as or otherwise support a means for outputting, via the cell and in accordance with the cell search procedure, a SIB including an IE that indicates a first set of SSB indices corresponding to a first set of resources of multiple candidate resources used for transmission of SSBs.

In some examples, a first system information message of the one or more system information messages indicates that the cell is using the second operating mode associated with the licensed RF spectrum band. In some examples, a second system information message of the one or more system information messages indicates a first set of resources of multiple candidate resources used for transmission of SSBs.

In some examples, the resource determining component 1460 may be configured as or otherwise support a means for determining whether a second set of resources of the multiple candidate resources is available for downlink shared channel resource mapping based on the second operating mode of the cell and a QCL relationship between the first set of resources and the second set of resources. In some examples, the downlink messaging component 1450 may be configured as or otherwise support a means for outputting a downlink message in accordance with the downlink shared channel resource mapping.

In some examples, the QCL identifying component 1465 may be configured as or otherwise support a means for identifying a QCL relationship between the first set of resources and a second set of resources of the multiple candidate resources based on a set of SSB indices associated with the first set of resources and a QCL parameter indicated by a MIB or a dedicated RRC message.

In some examples, the SSB outputting component 1440 may be configured as or otherwise support a means for outputting an indication of a first set of resources of multiple candidate resources used for transmission of SSBs. In some examples, the resource determining component 1460 may be configured as or otherwise support a means for determining that all of the multiple candidate resources except the first set of resources are available for downlink shared channel resource mapping in accordance with the second operating mode associated with the licensed RF spectrum band. In some examples, the downlink messaging component 1450 may be configured as or otherwise support a means for outputting a downlink message in accordance with the downlink shared channel resource mapping.

In some examples, to support outputting the one or more system information messages, the system information outputting component 1430 may be configured as or otherwise support a means for outputting, via the cell and in accordance with the cell search procedure, a first SIB indicating a first set of resources of multiple candidate resources used for transmission of SSBs.

In some examples, the LBT component 1445 may be configured as or otherwise support a means for performing an LBT procedure in accordance with the first operating mode of the cell. In some examples, the downlink messaging component 1450 may be configured as or otherwise support a means for outputting one or more downlink messages or SSBs based on a result of the LBT procedure.

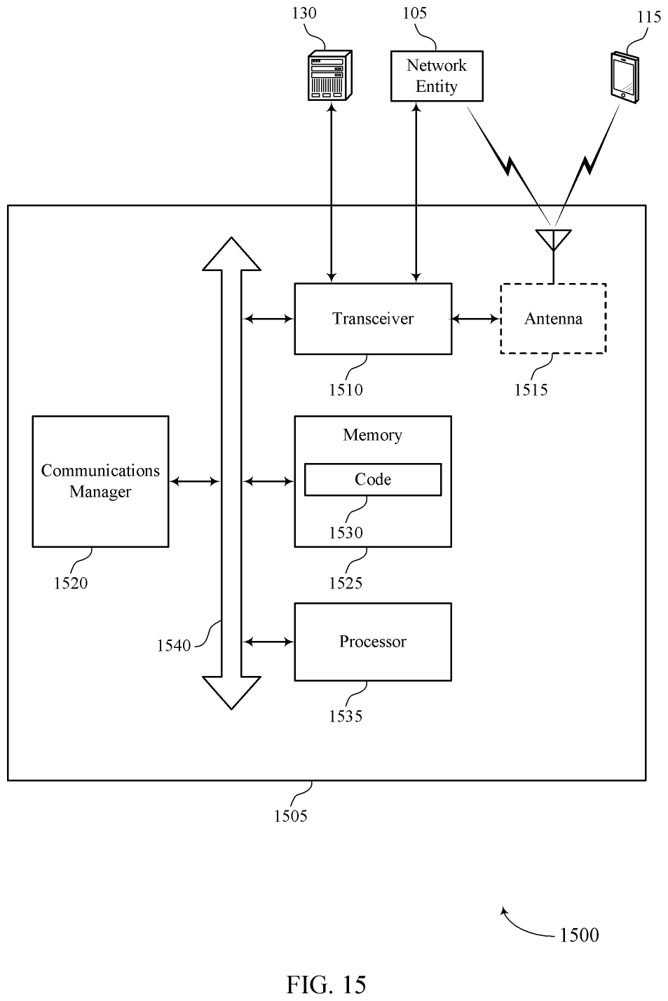

FIG. 15 shows a diagram of a system 1500 including a device 1505 that supports cell search procedures for licensed or shared RF spectrum bands in accordance with one or more aspects of the present disclosure. The device 1505 may be an example of or include the components of a device 1205, a device 1305, or a network entity 105, as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both, as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or memory components (for example, the processor 1535, or the memory 1525, or both), may be included in a chip or chip assembly that is installed in the device 1505. In some examples, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting cell search procedures for licensed or shared RF spectrum bands).

For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505. The processor 1535 may be any one or more suitable processors capable of executing scripts or instructions of one or more software programs stored in the device 1505 (such as within the memory 1525). In some implementations, the processor 1535 may be a component of a processing system. A processing system may generally refer to a system or series of machines or components that receives inputs and processes the inputs to produce a set of outputs (which may be passed to other systems or components of, for example, the device 1505).

For example, a processing system of the device 1505 may refer to a system including the various other components or subcomponents of the device 1505, such as the processor 1535, or the transceiver 1510, or the communications manager 1520, or other components or combinations of components of the device 1505. The processing system of the device 1505 may interface with other components of the device 1505, and may process information received from other components (such as inputs or signals) or output information to other components. For example, a chip or modem of the device 1505 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations.

In some implementations, the one or more interfaces may refer to an interface between the processing system of the chip or modem and a transmitter, such that the device 1505 may transmit information output from the chip or modem. Additionally, or alternatively, in some implementations, the one or more interfaces may refer to an interface between the processing system of the chip or modem and a receiver, such that the device 1505 may obtain information or signal inputs, and the information may be passed to the processing system. A person having ordinary skill in the art will readily recognize that a first interface also may obtain information or signal inputs, and a second interface also may output information or signal outputs.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communication at a network entity (e.g., the device 1505) in accordance with examples disclosed herein. For example, the communications manager 1520 may be configured as or otherwise support a means for performing a cell search procedure in accordance with an operating mode of a cell of the network entity, where the operating mode of the cell is unknown to a UE. The communications manager 1520 may be configured as or otherwise support a means for outputting, via the cell and in accordance with the cell search procedure, one or more system information messages indicating that the operating mode of the cell is either a first operating mode associated with a shared RF spectrum band or a second operating mode associated with a licensed RF spectrum band. The communications manager 1520 may be configured as or otherwise support a means for establishing a connection with the UE via the cell using the operating mode indicated by the one or more system information messages.

By including or configuring the communications manager 1520 in accordance with examples, as described herein, the device 1505 may support techniques for performing cell search procedures with greater efficiency and reduced latency, among other benefits. For example, if a UE is performing an initial access procedure in accordance with an unlicensed operating mode and the UE detects that the device 1505 is operating in a licensed RF spectrum band, the UE may use different parameters (bandwidth, SCS, frequency offset) for the remainder of the initial access procedure, which may increase the likelihood of the UE successfully establishing a connection with the device 1505. Moreover, the described techniques may increase the likelihood of the UE successfully receiving downlink messages from the device 1505 by enabling the UE to more accurately determine which resources are available for PDSCH resource mapping.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, the processor 1535, the memory 1525, the code 1530, or any combination thereof. For example, the code 1530 may include instructions executable by the processor 1535 to cause the device 1505 to perform various aspects of cell search procedures for licensed or shared RF spectrum bands, as described herein, or the processor 1535 and the memory 1525 may be otherwise configured to perform or support such operations.

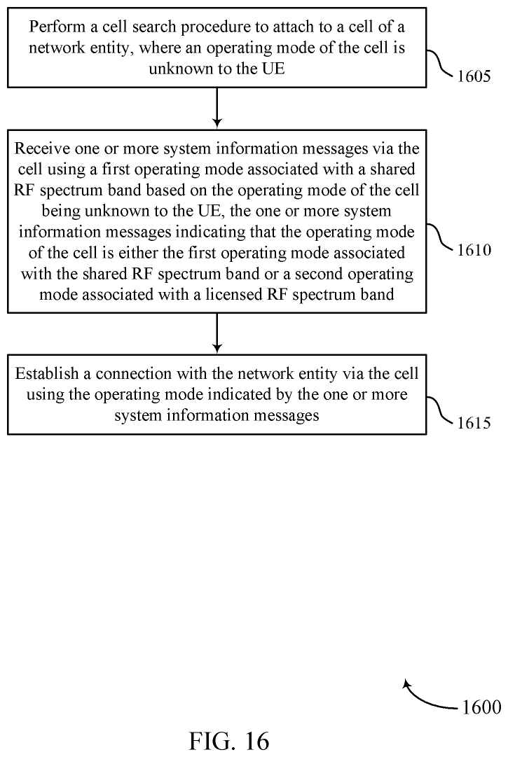

FIG. 16 shows a flowchart illustrating a method 1600 that supports cell search procedures for licensed or shared RF spectrum bands in accordance with one or more aspects of the present disclosure. Operations of the method 1600 may be implemented by a UE or components thereof. For example, operations of the method 1600 may be performed by a UE 115, as described with reference to FIGS. 1 through 11. In some examples, a UE may execute a set of instructions to control the functional elements of the UE to perform the functions described with reference to FIG. 16. Additionally, or alternatively, the UE may perform aspects of the described functions using special-purpose hardware.

At 1605, the UE may perform a cell search procedure to attach to a cell of a network entity, where an operating mode of the cell is unknown to the UE. The operations of 1605 may be performed in accordance with examples disclosed herein. In some examples, aspects of the operations of 1605 may be performed by a cell search component 1025, as described with reference to FIG. 10.

At 1610, the UE may receive one or more system information messages via the cell using a first operating mode associated with a shared RF spectrum band based on the operating mode of the cell being unknown to the UE, the one or more system information messages indicating that the operating mode of the cell is either the first operating mode associated with the shared RF spectrum band or a second operating mode associated with a licensed RF spectrum band. The operations of 1610 may be performed in accordance with examples disclosed herein. In some examples, aspects of the operations of 1610 may be performed by a system information component 1030, as described with reference to FIG. 10.

At 1615, the UE may establish a connection with the network entity via the cell using the operating mode indicated by the one or more system information messages. The operations of 1615 may be performed in accordance with examples disclosed herein. In some examples, aspects of the operations of 1615 may be performed by a connection establishment component 1035, as described with reference to FIG. 10.

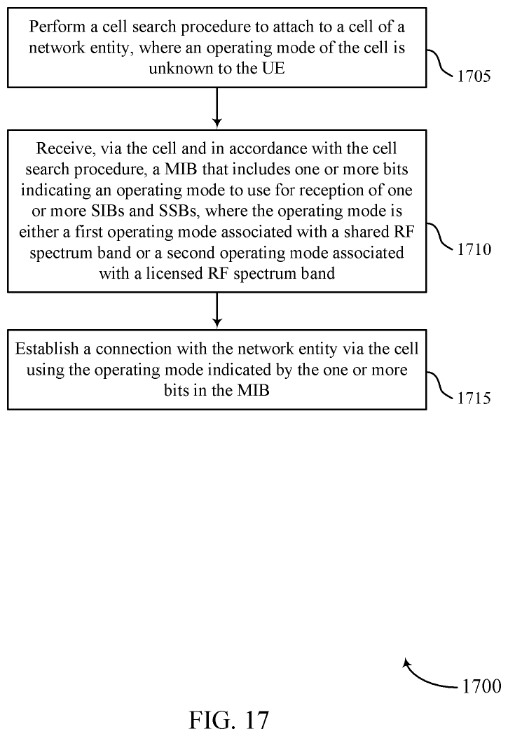

FIG. 17 shows a flowchart illustrating a method 1700 that supports cell search procedures for licensed or shared RF spectrum bands in accordance with one or more aspects of the present disclosure. Operations of the method 1700 may be implemented by a UE or components thereof. For example, operations of the method 1700 may be performed by a UE 115, as described with reference to FIGS. 1 through 11. In some examples, a UE may execute a set of instructions to control the functional elements of the UE to perform the functions described with reference to FIG. 17. Additionally, or alternatively, the UE may perform aspects of the described functions using special-purpose hardware.

At 1705, the UE may perform a cell search procedure to attach to a cell of a network entity, where an operating mode of the cell is unknown to the UE. The operations of 1705 may be performed in accordance with examples disclosed herein. In some examples, aspects of the operations of 1705 may be performed by a cell search component 1025, as described with reference to FIG. 10.

At 1710, the UE may receive, via the cell and in accordance with the cell search procedure, a MIB that includes one or more bits indicating an operating mode to use for reception of one or more SIBs and SSBs, where the operating mode is either a first operating mode associated with a shared RF spectrum band or a second operating mode associated with a licensed RF spectrum band. The operations of 1710 may be performed in accordance with examples disclosed herein. In some examples, aspects of the operations of 1710 may be performed by a system information component 1030, as described with reference to FIG. 10.

At 1715, the UE may establish a connection with the network entity via the cell using the operating mode indicated by the one or more bits in the MIB. The operations of 1715 may be performed in accordance with examples disclosed herein. In some examples, aspects of the operations of 1715 may be performed by a connection establishment component 1035, as described with reference to FIG. 10.

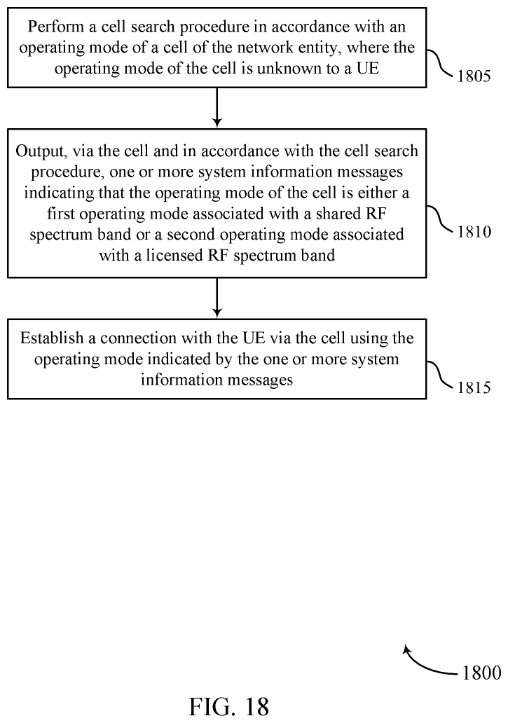

FIG. 18 shows a flowchart illustrating a method 1800 that supports cell search procedures for licensed or shared RF spectrum bands in accordance with one or more aspects of the present disclosure. The operations of the method 1800 may be implemented by a network entity or components thereof. For example, operations of the method 1800 may be performed by a network entity 105, as described with reference to FIGS. 1 through 7 and 12 through 15. In some examples, a network entity may execute a set of instructions to control the functional elements of the network entity to perform the functions described with reference to FIG. 18. Additionally, or alternatively, the network entity may perform aspects of the described functions using special-purpose hardware.

At 1805, the network entity may perform a cell search procedure in accordance with an operating mode of a cell of the network entity, where the operating mode of the cell is unknown to a UE. The operations of 1805 may be performed in accordance with examples disclosed herein. In some examples, aspects of the operations of 1805 may be performed by a cell searching component 1425, as described with reference to FIG. 14.

At 1810, the network entity may output, via the cell and in accordance with the cell search procedure, one or more system information messages indicating that the operating mode of the cell is either a first operating mode associated with a shared RF spectrum band or a second operating mode associated with a licensed RF spectrum band. The operations of 1810 may be performed in accordance with examples disclosed herein. In some examples, aspects of the operations of 1810 may be performed by a system information outputting component 1430, as described with reference to FIG. 14.

At 1815, the network entity may establish a connection with the UE via the cell using the operating mode indicated by the one or more system information messages. The operations of 1815 may be performed in accordance with examples disclosed herein. In some examples, aspects of the operations of 1815 may be performed by a connection establishing component 1435, as described with reference to FIG. 14.

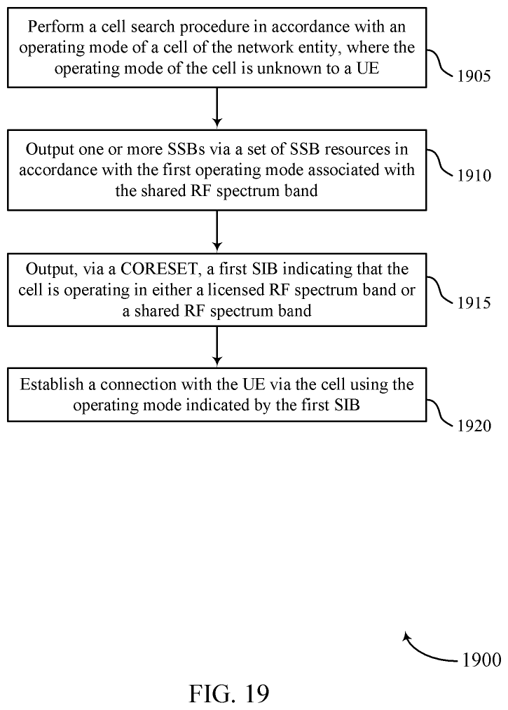

FIG. 19 shows a flowchart illustrating a method 1900 that supports cell search procedures for licensed or shared RF spectrum bands in accordance with one or more aspects of the present disclosure. Operations of the method 1900 may be implemented by a network entity or components thereof. For example, operations of the method 1900 may be performed by a network entity 105, as described with reference to FIGS. 1 through 7 and 12 through 15. In some examples, a network entity may execute a set of instructions to control the functional elements of the network entity to perform the functions described with reference to FIG. 19. Additionally, or alternatively, the network entity may perform aspects of the described functions using special-purpose hardware.

At 1905, the network entity may perform a cell search procedure in accordance with an operating mode of a cell of the network entity, where the operating mode of the cell is unknown to a UE. The operations of 1905 may be performed in accordance with examples disclosed herein. In some examples, aspects of the operations of 1905 may be performed by a cell searching component 1425, as described with reference to FIG. 14.

At 1910, the network entity may output one or more SSBs via a set of SSB resources in accordance with the first operating mode associated with the shared RF spectrum band. The operations of 1910 may be performed in accordance with examples disclosed herein. In some examples, aspects of the operations of 1910 may be performed by an SSB outputting component 1440, as described with reference to FIG. 14.

At 1915, the network entity may output, via a CORESET, a first SIB indicating that the cell is operating in either a licensed RF spectrum band or a shared RF spectrum band. The operations of 1915 may be performed in accordance with examples disclosed herein. In some examples, aspects of the operations of 1915 may be performed by a system information outputting component 1430, as described with reference to FIG. 14.

At 1920, the network entity may establish a connection with the UE via the cell using the operating mode indicated by the first SIB. The operations of 1920 may be performed in accordance with examples disclosed herein. In some examples, aspects of the operations of 1920 may be performed by a connection establishing component 1435, as described with reference to FIG. 14.

The following provides an overview of aspects of the present disclosure:

Aspect 1: A method for wireless communication at a UE, comprising: performing a cell search procedure to attach to a cell of a network entity, wherein an operating mode of the cell is unknown to the UE: receiving one or more system information messages via the cell using a first operating mode associated with a shared radio frequency spectrum band based at least in part on the operating mode of the cell being unknown to the UE, the one or more system information messages indicating that the operating mode of the cell is either the first operating mode associated with the shared radio frequency spectrum band or a second operating mode associated with a licensed radio frequency spectrum band; and establishing a connection with the network entity via the cell using the operating mode indicated by the one or more system information messages.

Aspect 2: The method of aspect 1, wherein receiving the one or more system information messages comprises: receiving, via the cell and in accordance with the cell search procedure, a master information block comprising one or more bits that indicate an operating mode to use for reception of one or more system information blocks and synchronization signal blocks, the operating mode comprising either the first operating mode or the second operating mode.

Aspect 3: The method of aspect 2, further comprising: determining one or more of a subcarrier spacing, a bandwidth, a maximum quantity of candidate resources available for transmission of synchronization signal blocks, a frequency offset, or a time duration to use for reception of the one or more system information blocks and synchronization signal blocks based at least in part on the operating mode of the cell.

Aspect 4: The method of any of aspects 2 through 3, wherein the master information block that indicates one or more of a system frame number, a common subcarrier spacing, a synchronization signal block subcarrier offset, a demodulation reference signal position field, a downlink control channel resource configuration, a control resource set configuration, a cell barring parameter, or an intra-frequency reselection parameter for the cell search procedure.

Aspect 5: The method of any of aspects 2 through 4, wherein one or both of a spare bit or a future extension bit in the master information block indicate the operating mode of the cell.

Aspect 6: The method of any of aspects 1 through 5, wherein receiving the one or more system information messages comprises: monitoring a set of synchronization signal block resources and a control resource set in accordance with the first operating mode associated with the shared radio frequency spectrum band; receiving one or more synchronization signal blocks via the set of synchronization signal block resources; and receiving, via the control resource set, a first system information block indicating that the cell is operating in either the licensed radio frequency spectrum band or the shared radio frequency spectrum band.

Aspect 7: The method of aspect 6, wherein receiving the first system information block comprises: monitoring the control resource set using one or more of a subcarrier spacing, a bandwidth, a resource block offset, or a time duration associated with the first operating mode.

Aspect 8: The method of any of aspects 1 through 7, wherein receiving the one or more system information messages comprises: receiving, via the cell and in accordance with the cell search procedure, a system information block comprising an information element that indicates a first set of synchronization signal block indices corresponding to a first set of resources of a plurality of candidate resources used for transmission of synchronization signal blocks.

Aspect 9: The method of any of aspects 1 through 8, wherein a first system information message of the one or more system information messages indicates that the cell is using the second operating mode associated with the licensed radio frequency spectrum band; and a second system information message of the one or more system information messages indicates a first set of resources of a plurality of candidate resources used for transmission of synchronization signal blocks.

Aspect 10: The method of aspect 9, further comprising: determining whether a second set of resources of the plurality of candidate resources is available for downlink shared channel resource mapping based at least in part on the second operating mode of the cell and a quasi-co-location relationship between the first set of resources and the second set of resources; and monitoring for a downlink message in accordance with the downlink shared channel resource mapping.

Aspect 11: The method of any of aspects 9 through 10, further comprising: identifying a quasi-co-location relationship between the first set of resources and a second set of resources of the plurality of candidate resources based at least in part on a set of synchronization signal block indices associated with the first set of resources and a quasi-co-location parameter indicated by a master information block or a dedicated radio resource control message.

Aspect 12: The method of any of aspects 1 through 11, further comprising: receiving an indication of a first set of resources of a plurality of candidate resources used for transmission of synchronization signal blocks: determining that all of the plurality of candidate resources except the first set of resources are available for downlink shared channel resource mapping based at least in part on the one or more system information messages indicating that the cell is operating in the licensed radio frequency spectrum band; and monitoring for a downlink message in accordance with the downlink shared channel resource mapping.

Aspect 13: The method of any of aspects 1 through 12, wherein receiving the one or more system information messages comprises: receiving, via the cell and in accordance with the cell search procedure, a first system information message indicating a first set of resources of a plurality of candidate resources used for transmission of synchronization signal blocks.

Aspect 14: The method of aspect 13, further comprising: receiving a downlink message via a second set of resources of the plurality of candidate resources based at least in part on the first system information message, wherein the second set of resources is determined according to the operating mode of the cell.

Aspect 15: A method for wireless communication at a network entity, comprising: performing a cell search procedure in accordance with an operating mode of a cell of the network entity, wherein the operating mode of the cell is unknown to a UE: outputting, via the cell and in accordance with the cell search procedure, one or more system information messages indicating that the operating mode of the cell is either a first operating mode associated with a shared radio frequency spectrum band or a second operating mode associated with a licensed radio frequency spectrum band; and establishing a connection with the UE via the cell using the operating mode indicated by the one or more system information messages.

Aspect 16: The method of aspect 15, wherein outputting the one or more system information messages comprises: outputting, via the cell and in accordance with the cell search procedure, a master information block comprising one or more bits that indicate an operating mode to use for reception of one or more system information blocks and synchronization signal blocks, the operating mode comprising either the first operating mode or the second operating mode.

Aspect 17: The method of aspect 16, further comprising: determining one or more of a subcarrier spacing, a bandwidth, a maximum quantity of candidate resources available for transmission of synchronization signal blocks, a frequency offset, or a time duration to use for transmission of the one or more system information blocks and synchronization signal blocks based at least in part on the operating mode of the cell.

Aspect 18: The method of any of aspects 16 through 17, wherein the master information block that indicates one or more of a system frame number, a common subcarrier spacing, a synchronization signal block subcarrier offset, a demodulation reference signal position field, a downlink control channel resource configuration, a control resource set configuration, a cell barring parameter, or an intra-frequency reselection parameter for the cell search procedure.

Aspect 19: The method of any of aspects 16 through 18, wherein one or both of a spare bit or a future extension bit in the master information block indicate the operating mode of the cell.

Aspect 20: The method of any of aspects 15 through 19, wherein outputting the one or more system information messages comprises: outputting one or more synchronization signal blocks via a set of synchronization signal block resources in accordance with the first operating mode associated with the shared radio frequency spectrum band; and outputting, via a control resource set, a first system information block indicating that the cell is operating in either the licensed radio frequency spectrum band or the shared radio frequency spectrum band.

Aspect 21: The method of aspect 20, wherein outputting the first system information block comprises: outputting the first system information block via the control resource set using one or more of a subcarrier spacing, a bandwidth, a resource block offset, or a time duration associated with the first operating mode.

Aspect 22: The method of any of aspects 15 through 21, wherein outputting the one or more system information messages comprises: outputting, via the cell and in accordance with the cell search procedure, a system information block comprising an information element that indicates a first set of synchronization signal block indices corresponding to a first set of resources of a plurality of candidate resources used for transmission of synchronization signal blocks.

Aspect 23: The method of any of aspects 15 through 22, wherein a first system information message of the one or more system information messages indicates that the cell is using the second operating mode associated with the licensed radio frequency spectrum band; and a second system information message of the one or more system information messages indicates a first set of resources of a plurality of candidate resources used for transmission of synchronization signal blocks.

Aspect 24: The method of aspect 23, further comprising: determining whether a second set of resources of the plurality of candidate resources is available for downlink shared channel resource mapping based at least in part on the second operating mode of the cell and a quasi-co-location relationship between the first set of resources and the second set of resources; and outputting a downlink message in accordance with the downlink shared channel resource mapping.

Aspect 25: The method of any of aspects 23 through 24, further comprising: identifying a quasi-co-location relationship between the first set of resources and a second set of resources of the plurality of candidate resources based at least in part on a set of synchronization signal block indices associated with the first set of resources and a quasi-co-location parameter indicated by a master information block or a dedicated radio resource control message.

Aspect 26: The method of any of aspects 23 through 25, further comprising: outputting an indication of a first set of resources of a plurality of candidate resources used for transmission of synchronization signal blocks: determining that all of the plurality of candidate resources except the first set of resources are available for downlink shared channel resource mapping in accordance with the second operating mode associated with the licensed radio frequency spectrum band; and outputting a downlink message in accordance with the downlink shared channel resource mapping.

Aspect 27: The method of any of aspects 15 through 26, wherein outputting the one or more system information messages comprises: outputting, via the cell and in accordance with the cell search procedure, a first system information block indicating a first set of resources of a plurality of candidate resources used for transmission of synchronization signal blocks.

Aspect 28: The method of any of aspects 15 through 27, further comprising: performing a listen-before-talk procedure in accordance with the first operating mode of the cell; and outputting one or more downlink messages or synchronization signal blocks based at least in part on a result of the listen-before-talk procedure.

Aspect 29: An apparatus for wireless communication at a UE, comprising a processor, memory coupled with the processor, and instructions stored in the memory, where the instructions are executable by the processor to cause the apparatus to perform a method of any of aspects 1 through 14.

Aspect 30: An apparatus for wireless communication at a UE, comprising at least one means for performing a method of any of aspects 1 through 14.

Aspect 31: A non-transitory computer-readable medium storing code for wireless communication at a UE, the code comprising instructions executable by a processor to perform a method of any of aspects 1 through 14.

Aspect 32: An apparatus for wireless communication at a network entity, comprising a processor, memory coupled with the processor, and instructions stored in the memory, where the instructions are executable by the processor to cause the apparatus to perform a method of any of aspects 15 through 28.

Aspect 33: An apparatus for wireless communication at a network entity, comprising at least one means for performing a method of any of aspects 15 through 28.

Aspect 34: A non-transitory computer-readable medium storing code for wireless communication at a network entity, the code comprising instructions executable by a processor to perform a method of any of aspects 15 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
a processor;
memory coupled with the processor; and
instructions stored in the memory and executable by the processor to cause the apparatus to:
perform a cell search procedure to attach to a cell of a network entity, wherein an operating mode of the cell is unknown to the UE;
receive one or more system information messages via the cell using a first operating mode associated with a shared radio frequency spectrum band based at least in part on the operating mode of the cell being unknown to the UE, the one or more system information messages indicating that the operating mode of the cell is either the first operating mode associated with the shared radio frequency spectrum band or a second operating mode associated with a licensed radio frequency spectrum band; and
establish a connection with the network entity via the cell using the operating mode indicated by the one or more system information messages.

2. The apparatus of claim 1, wherein, to receive the one or more system information messages, the instructions are executable by the processor to cause the apparatus to:
receive, via the cell and in accordance with the cell search procedure, a master information block comprising one or more bits that indicate an operating mode to use for reception of one or more system information blocks and synchronization signal blocks, the operating mode comprising either the first operating mode or the second operating mode.

3. The apparatus of claim 2, wherein the instructions are further executable by the processor to cause the apparatus to:
determine one or more of a subcarrier spacing, a bandwidth, a maximum quantity of candidate resources available for transmission of synchronization signal blocks, a frequency offset, or a time duration to use for reception of the one or more system information blocks and synchronization signal blocks based at least in part on the operating mode of the cell.

4. The apparatus of claim 2, wherein the master information block that indicates one or more of a system frame number, a common subcarrier spacing, a synchronization signal block subcarrier offset, a demodulation reference signal position field, a downlink control channel resource configuration, a control resource set configuration, a cell barring parameter, or an intra-frequency reselection parameter for the cell search procedure.

5. The apparatus of claim 2, wherein one or both of a spare bit or a future extension bit in the master information block indicate the operating mode of the cell.

6. The apparatus of claim 1, wherein, to receive the one or more system information messages, the instructions are executable by the processor to cause the apparatus to:
monitor a set of synchronization signal block resources and a control resource set in accordance with the first operating mode associated with the shared radio frequency spectrum band;
receive one or more synchronization signal blocks via the set of synchronization signal block resources; and
receive, via the control resource set, a first system information block indicating that the cell is operating in either the licensed radio frequency spectrum band or the shared radio frequency spectrum band.

7. The apparatus of claim 6, wherein to receive the first system information block, the instructions are executable by the processor to cause the apparatus to:
monitor the control resource set using one or more of a subcarrier spacing, a bandwidth, a resource block offset, or a time duration associated with the first operating mode.

8. The apparatus of claim 1, wherein, to receive the one or more system information messages, the instructions are executable by the processor to cause the apparatus to:
receive, via the cell and in accordance with the cell search procedure, a system information block comprising an information element that indicates a first set of synchronization signal block indices corresponding to a first set of resources of a plurality of candidate resources used for transmission of synchronization signal blocks.

9. The apparatus of claim 1, wherein:
a first system information message of the one or more system information messages indicates that the cell is using the second operating mode associated with the licensed radio frequency spectrum band; and
a second system information message of the one or more system information messages indicates a first set of resources of a plurality of candidate resources used for transmission of synchronization signal blocks.

10. The apparatus of claim 9, wherein the instructions are further executable by the processor to cause the apparatus to:
determine whether a second set of resources of the plurality of candidate resources is available for downlink shared channel resource mapping based at least in part on the second operating mode of the cell and a quasi-co-location relationship between the first set of resources and the second set of resources; and
monitor for a downlink message in accordance with the downlink shared channel resource mapping.

11. The apparatus of claim 9, wherein the instructions are further executable by the processor to cause the apparatus to:
identify a quasi-co-location relationship between the first set of resources and a second set of resources of the plurality of candidate resources based at least in part on a set of synchronization signal block indices associated with the first set of resources and a quasi-co-location parameter indicated by a master information block or a dedicated radio resource control message.

12. The apparatus of claim 1, wherein the instructions are further executable by the processor to cause the apparatus to:
receive an indication of a first set of resources of a plurality of candidate resources used for transmission of synchronization signal blocks;
determine that all of the plurality of candidate resources except the first set of resources are available for downlink shared channel resource mapping based at least in part on the one or more system information messages indicating that the cell is operating in the licensed radio frequency spectrum band; and
monitor for a downlink message in accordance with the downlink shared channel resource mapping.

13. The apparatus of claim 1, wherein, to receive the one or more system information messages, the instructions are executable by the processor to cause the apparatus to:
receive, via the cell and in accordance with the cell search procedure, a first system information message indicating a first set of resources of a plurality of candidate resources used for transmission of synchronization signal blocks.

14. The apparatus of claim 13, wherein the instructions are further executable by the processor to cause the apparatus to:
receive a downlink message via a second set of resources of the plurality of candidate resources based at least in part on the first system information message, wherein the second set of resources is determined according to the operating mode of the cell.

15. An apparatus for wireless communication at a network entity, comprising:
a processor;
memory coupled with the processor; and
instructions stored in the memory and executable by the processor to cause the apparatus to:
perform a cell search procedure in accordance with an operating mode of a cell of the network entity, wherein the operating mode of the cell is unknown to a user equipment (UE);
output, via the cell and in accordance with the cell search procedure, one or more system information messages indicating that the operating mode of the cell is either a first operating mode associated with a shared radio frequency spectrum band or a second operating mode associated with a licensed radio frequency spectrum band; and
establish a connection with the UE via the cell using the operating mode indicated by the one or more system information messages.

16. The apparatus of claim 15, wherein, to output the one or more system information messages, the instructions are executable by the processor to cause the apparatus to:
output, via the cell and in accordance with the cell search procedure, a master information block comprising one or more bits that indicate an operating mode to use for reception of one or more system information blocks and synchronization signal blocks, the operating mode comprising either the first operating mode or the second operating mode.

17. The apparatus of claim 16, wherein the instructions are further executable by the processor to cause the apparatus to:
determine one or more of a subcarrier spacing, a bandwidth, a maximum quantity of candidate resources available for transmission of synchronization signal blocks, a frequency offset, or a time duration to use for transmission of the one or more system information blocks and synchronization signal blocks based at least in part on the operating mode of the cell.

18. The apparatus of claim 16, wherein the master information block that indicates one or more of a system frame number, a common subcarrier spacing, a synchronization signal block subcarrier offset, a demodulation reference signal position field, a downlink control channel resource configuration, a control resource set configuration, a cell barring parameter, or an intra-frequency reselection parameter for the cell search procedure.

19. The apparatus of claim 16, wherein one or both of a spare bit or a future extension bit in the master information block indicate the operating mode of the cell.

20. The apparatus of claim 15, wherein, to output the one or more system information messages, the instructions are executable by the processor to cause the apparatus to:
output one or more synchronization signal blocks via a set of synchronization signal block resources in accordance with the first operating mode associated with the shared radio frequency spectrum band; and
output, via a control resource set, a first system information block indicating that the cell is operating in either the licensed radio frequency spectrum band or the shared radio frequency spectrum band.

21-30. (canceled)
